(19) United States
(12) Patent Application Publication
(10) Pub. No.: US 2026/0241283 A1
(43) Pub. Date: Aug. 20, 2026

(54) METHOD FOR PLAYING SOUND EFFECT, TERMINAL DEVICE AND STORAGE MEDIUM

(71) Applicant: TENCENT TECHNOLOGY (SHENZHEN) COMPANY LIMITED, Shenzhen (CN)

(72) Inventor: Yizhou LI, Shenzhen (CN)

(21) Appl. No.: 19/646,099

(22) Filed: Apr. 13, 2026

Related U.S. Application Data
(63) Continuation of application No. PCT/CN2025/081591, filed on Mar. 10, 2025.

(30) Foreign Application Priority Data
Mar. 27, 2024 (CN) 202410376871.7

(51) Int. Cl. A63F 13/54; G10K 15/02

(52) U.S. Cl. CPC A63F 13/54; G10K 15/02

(57) ABSTRACT

A method for playing a sound effect, performed by a terminal device and includes displaying a virtual environment comprising a first virtual object; and playing, in response to that the first virtual object is located in a visual blocking region in the virtual environment and the first virtual object triggers a sound-generating event in the visual blocking region, a sound effect of the sound-generating event after reduction processing, the visual blocking region being configured for producing a blocking effect on a virtual element in the visual blocking region, and the reduction processing being configured for reducing an effect of the sound effect in distinguishing a location of the first virtual object.

### CROSS-REFERENCES TO RELATED APPLICATIONS

This application is a continuation application of PCT Patent Application No. PCT/CN2025/081591, filed on Mar. 10, 2025, which claims the benefit of priority to Chinese Patent Application No. 202410376871.7, filed on Mar. 27, 2024, all of which is incorporated in their entirety herein by reference.

### FIELD OF THE TECHNOLOGY

Embodiments of present disclosure relate to the technical field of computers, and in particular, to a method for playing a sound effect, a method for displaying a voiceprint identifier, an apparatus, a terminal device, and storage medium.

### BACKGROUND OF THE DISCLOSURE

As application development technology continues to advance, sound effects in game applications have become increasingly rich and diverse.

In the related art, sound effects played by a game application that users hear, such as footsteps of a virtual object in a virtual environment, are only related to distance and location of the virtual object. This results in the sound effects played by the game application being monotonous.

### SUMMARY

One embodiment of the present disclosure provides a method for playing a sound effect, performed by a terminal device. The method includes displaying a virtual environment comprising a first virtual object; and playing, in response to that the first virtual object is located in a visual blocking region in the virtual environment and the first virtual object triggers a sound-generating event in the visual blocking region, a sound effect of the sound-generating event after reduction processing, the visual blocking region being configured for producing a blocking effect on a virtual element in the visual blocking region, and the reduction processing being configured for reducing an effect of the sound effect in distinguishing a location of the first virtual object.

Another embodiment of the present disclosure provides a terminal device. The terminal device includes one or more processors and a memory containing a computer program that, when being executed, causes the one or more processors to perform: displaying a virtual environment comprising a first virtual object; and playing, in response to that the first virtual object is located in a visual blocking region in the virtual environment and the first virtual object triggers a sound-generating event in the visual blocking region, a sound effect of the sound-generating event after reduction processing, the visual blocking region being configured for producing a blocking effect on a virtual element in the visual blocking region, and the reduction processing being configured for reducing an effect of the sound effect in distinguishing a location of the first virtual object.

Another embodiment of the present disclosure provides a non-transitory computer-readable storage medium containing a computer program that, when being executed, causes at least one processor to perform: displaying a virtual environment comprising a first virtual object; and playing, in response to that the first virtual object is located in a visual blocking region in the virtual environment and the first virtual object triggers a sound-generating event in the visual blocking region, a sound effect of the sound-generating event after reduction processing, the visual blocking region being configured for producing a blocking effect on a virtual element in the visual blocking region, and the reduction processing being configured for reducing an effect of the sound effect in distinguishing a location of the first virtual object.

The above general descriptions and the detailed description hereinafter are merely exemplary and explanatory, and cannot limit present disclosure.

### BRIEF DESCRIPTION OF THE DRAWINGS

FIG. 1 is a schematic diagram of a virtual environment according to an embodiment of present disclosure.

FIG. 2 is a schematic diagram of a computer system according to an embodiment of present disclosure.

FIG. 3 is a flowchart of a method for playing audio according to an embodiment of present disclosure.

FIG. 4 is a schematic diagram of a configuration interface according to an embodiment of present disclosure.

FIG. 5 is a flowchart of a method for playing audio according to another embodiment of present disclosure.

FIG. 6 is a schematic diagram of a configuration interface according to another embodiment of present disclosure.

FIG. 7 is a flowchart of a method for playing audio according to yet another embodiment of present disclosure.

FIG. 8 is a schematic diagram of a visual blocking region according to an embodiment of present disclosure.

FIG. 9 is a flowchart of a method for displaying a voiceprint identifier according to an embodiment of present disclosure.

FIG. 10 is a schematic diagram of a visual blocking region according to another embodiment of present disclosure.

FIG. 11 is a block diagram of an apparatus for playing audio according to an embodiment of present disclosure.

FIG. 12 is a block diagram of an apparatus for displaying a voiceprint identifier according to an embodiment of present disclosure.

FIG. 13 is a block diagram of a terminal device according to an embodiment of present disclosure.

### DESCRIPTION OF EMBODIMENTS

The exemplary embodiments are described in detail herein, and are exemplarily denoted in the accompanying drawings. When the following descriptions involve accompanying drawings, unless otherwise indicated, the same numerals in different accompanying drawings denote the same or similar elements. The following implementations described in the following exemplary embodiments do not denote all implementations that are consistent with present disclosure. On the contrary, the implementations are merely examples of the method that are consistent with some aspects of present disclosure described in detail in the appended claims.

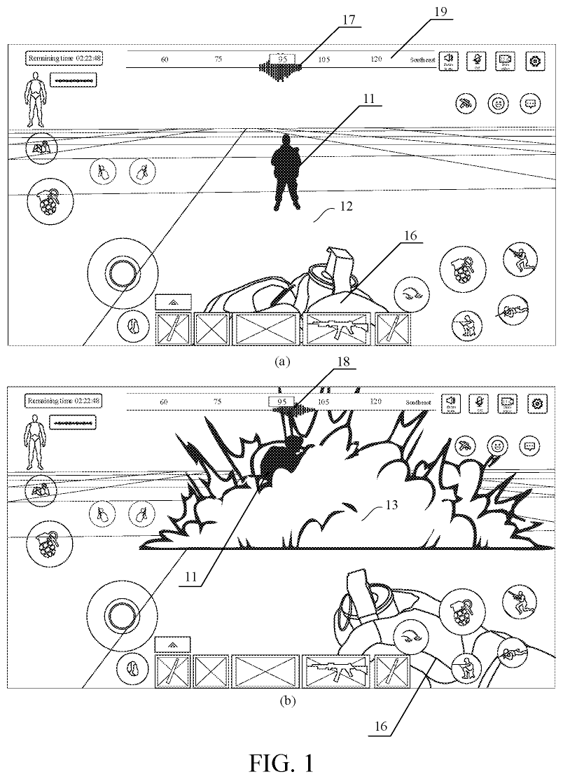

In some embodiments, with reference to subfigure (a) of FIG. 1, when the location of the virtual object 11 is changed, if the virtual object 11 is located in a region 12 outside a smoke range of a smoke bomb, an initial sound effect corresponding to each time of location change of the virtual object 11 is directly played. As shown in subfigure (b) of FIG. 1, if the virtual object 11 is located in a coverage region 13 of smoke generated by the smoke bomb, reduction processing is performed on an initial sound effect corresponding to a location change. A reduced sound effect corresponding to the location change is obtained. Moreover, the reduced sound effect corresponding to the location change is played.

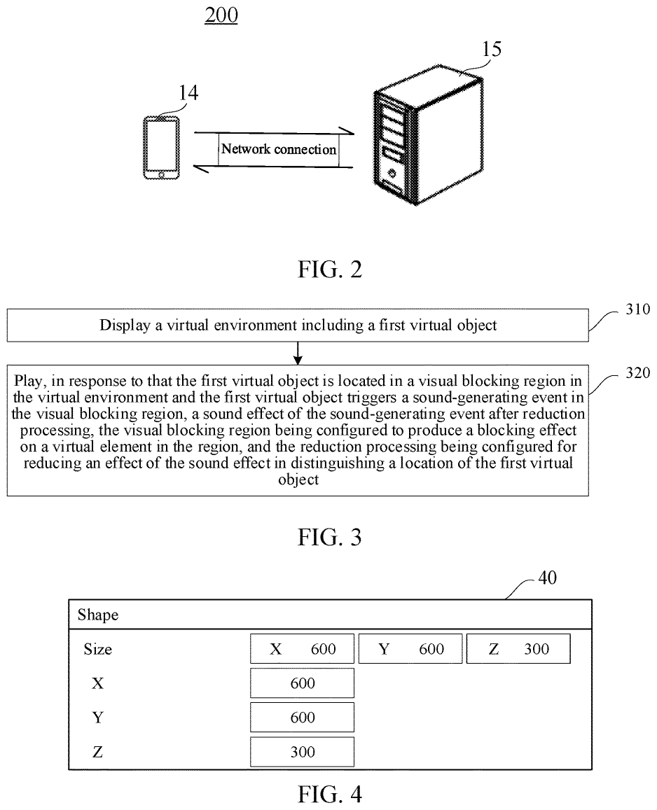

With reference to FIG. 2, a schematic diagram of a computer system according to an embodiment of present disclosure is shown. The computer system may be implemented as a system for playing a sound effect. As shown in FIG. 2, the system 200 may include a terminal device 14.

A target application, such as a client of a target application, is mounted and run in the terminal device 14. In some embodiments, a user account is logged in the client. The terminal device is an electronic device having data computing, processing, and storage capabilities. The terminal device may be a smartphone, a tablet computer, a personal computer (PC), a wearable device, etc. This is not limited in the embodiments of present disclosure. The target application may be a game application, such as a shooting game application, a multiplayer gunfight survival game application, a battle royale survival game application, a location based service (LBS) game application, or a multiplayer online battle arena (MOBA) game application. This is not limited in the embodiments of present disclosure. The target application may further be any application having a sound effect displaying function, such as a social application, a payment application, a video application, a music application, a shopping application, or a news application. In the methods provided in the embodiments of present disclosure, a performing subject of the operations may be the terminal device 14, such as a client run in the terminal device 14.

In some embodiments, the system 200 further includes a server 15. A communication connection (such as a network connection) is established between the server 15 and the terminal device 14. The server 15 is configured to provide a background service for the target application. The server may be an independent physical server, or may be a server cluster or a distributed system composed of a plurality of physical servers, or may be a cloud server providing a cloud computing service. In the methods provided in the embodiments of present disclosure, a performing subject of the operations may be the terminal device 14. The operations in the embodiments of present disclosure may be performed by the terminal device 14 and the server 15 alternately.

The technical solutions of present disclosure are introduced and described below through some embodiments.

With reference to FIG. 3, a flowchart of a method for playing a sound effect according to an embodiment of present disclosure is shown. In the embodiment, an example in which the method is applied to the client introduced above is taken for description. The method may include at least one of the following operations (310 and 320).

Operation 310: Display a virtual environment interface including a first virtual object.

In some embodiments, a virtual object controlled by a user account logged in the client introduced above may be a second virtual object in a virtual environment. The second virtual object and the first virtual object are different virtual objects participating in the same round of game and located in the same virtual environment. The terminal device 14 introduced above is configured to present a virtual environment (including another virtual object in the virtual environment, such as the first virtual object) observed by controlling an angle of view of the second virtual object, and play a simulated sound effect heard by the second virtual object in the virtual environment. To be specific, a user can hear a sound effect in the virtual environment by controlling the second virtual object.

In some embodiments, the terminal device 14 introduced above may include a first terminal device and a second terminal device. A first client of the target application is mounted on the first terminal device. A second client of the target application is mounted on the second terminal device. A first user account of a first user controls a first virtual object in the first client of the target application. A second user account of a second user controls a second virtual object (that is, a mainly controlled virtual object) in the second client of the target application. Certainly, in addition to belonging to a virtual object controlled by the user, the first virtual object in the embodiments of present disclosure may alternatively belong to a virtual object (an artificial intelligence virtual object) controlled by the server. In some embodiments, the first virtual object and the second virtual object are located in the same virtual environment. In some embodiments, the first virtual object and the second virtual object may belong to the same camp, the same team, and the same organization, or have a friend relationship, or have temporary communication permission. In this case, the second virtual object is considered as a friend virtual object of the first virtual object. In some embodiments, the first virtual object and the second virtual object may belong to different camps, different teams, and different organizations, or have an adversarial relationship. In this case, the second virtual object is considered as an enemy virtual object of the first virtual object. In some embodiments, a client mounted in a first terminal device is same as a client mounted in a second terminal device, or the clients mounted in the two terminals are clients of the same type on different operating system platforms (Android or IOS). The first terminal device may generally refer to one of a plurality of terminal devices, and the second terminal device may generally refer to another one of the plurality of terminal devices. In the embodiment, merely the first terminal device and the second terminal device are taken as an example for description.

In some embodiments, the virtual environment is an environment displayed (or provided) when a target application is run on a terminal device. The virtual environment may be a simulated environment of the real world, a semi-simulated and semi-fictional environment, or a completely fictional environment. The virtual environment may be any one of a two-dimensional virtual environment, a 2.5-dimensional virtual environment, and a three-dimensional virtual environment. This is not limited in the embodiments of present disclosure. Exemplarily, the virtual environment including the first virtual object is displayed on the second terminal device. In some embodiments, a performing subject of the method provided in the embodiments of present disclosure is the second terminal device.

In some embodiments, the virtual object is a virtual element that can trigger a sound-generating event in the virtual environment. The virtual object may be a movable object in the virtual environment, or may be an immovable object fixedly located in the virtual environment. When the virtual object is a movable object in the virtual environment, a user can control an activity of the corresponding virtual object in the virtual environment through a function provided by the target application, or the target application itself controls an activity of the virtual object in the virtual environment. For example, the target application is a game application, and the virtual object may refer to a game character. When the virtual object is a game character, the virtual object may be a person, an animal, a cartoon character, or another form. This is not limited in the embodiments of present disclosure. The virtual object may alternatively be a virtual item. The virtual item may be a virtual vehicle (such as a virtual car, a virtual flight vehicle, a virtual motorcycle, a virtual bicycle, a virtual watercraft, or a virtual skateboard), a virtual attack item (such as a virtual shooting item, a virtual tool, or a virtual throwing item), a virtual sound-generating item (such as a virtual horn, a virtual sounder, a virtual whistle, or a virtual musical instrument), etc.

In some embodiments, the virtual object may be presented in a three-dimensional form or a two-dimensional form. This is not limited in the embodiments of present disclosure. In some embodiments, the virtual object is located in the virtual environment. When the virtual environment is a three-dimensional virtual environment, the virtual object may be a three-dimensional model created based on an animation bone technology. The virtual object has its own shape and volume in the three-dimensional virtual environment, and occupies a portion of space in the three-dimensional virtual environment.

In the embodiments of present disclosure, the virtual environment is displayed on the terminal device in at least three modes. A first mode is a first-person angle of view. To be specific, a virtual camera is mounted on a head of the second virtual object, and a picture obtained by the virtual camera by observing the virtual environment is taken as a displayed presentation picture of the virtual environment. In this case, the displayed picture of the virtual environment include no second virtual object. The second mode is a third-person angle of view. To be specific, a virtual camera is mounted at a rear of the second virtual object, and a picture obtained by the virtual camera by observing the virtual environment is taken as a displayed picture of the virtual environment. In this case, the displayed picture of the virtual environment may include a portion or all of the second virtual object. An orientation of the first-person angle of view and an orientation of the third-person angle of view both change with an orientation of the first virtual object. A third mode is another angle of view having a particular direction, and an orientation of the angle of view does not change. To be specific, a picture obtained by the virtual camera by observing an entire virtual environment according to a particular orientation is taken as a displayed presentation picture of the virtual environment. In this case, the second virtual object may be displayed in a middle of the picture of the virtual environment, or may be displayed at another location in the picture of the virtual environment, or is not displayed in the displayed picture of the virtual environment. This is not limited in present disclosure.

Operation 320: Play, when the first virtual object is located in a visual blocking region in the virtual environment and the first virtual object triggers a sound-generating event in the visual blocking region, a sound effect of the sound-generating event after reduction processing, the visual blocking region being configured for producing a blocking effect on a virtual element in the region, and the reduction processing being configured for reducing an effect of the sound effect in distinguishing a location of the first virtual object.

In some embodiments, the visual blocking region is a region in which the virtual element in the region is visually blocked. Exemplarily, the visual blocking region does not change an original virtual element in the region. Exemplarily, the visual blocking region is an element that is further superposed on an upper layer of the original virtual element in the region and that is configured for blocking the virtual element. Exemplarily, the visual blocking herein includes, but is not limited to, smoke blocking, rain blocking, snowflake blocking, etc.

In some embodiments, the visual blocking region is configured for producing a blocking effect on the virtual element in the region. Exemplarily, the blocking effect herein may refer to blocking in clarity. Exemplarily, the blocking effect herein includes at least one of the following: changing the virtual element in the region from a visible state to an invisible state, and changing the virtual element in the region from a clearly visible state to a vaguely visible state. Exemplarily, the visible state refers to a state in which a user can see the virtual element on a user interface. Exemplarily, the invisible state refers to a state in which the user cannot see the virtual element on the user interface. Exemplarily, the clearly visible state means that clarity of the virtual element seen by the user on the user interface is greater than or equal to a preset value. Exemplarily, the vaguely visible state means that the clarity of the virtual element seen by the user on the user interface is less than the preset value.

In some embodiments, the visual blocking region is a region of a preset location in the virtual environment or a dynamically triggered region. Exemplarily, when the visual blocking region is the region of the preset location in the virtual environment, the location of the visual blocking region is preset by a developer in advance. Exemplarily, an area or a size of the visual blocking region is preset. Exemplarily, the visual blocking region is a spherical region with the target location as a center and having a preset radius. Exemplarily, when the visual blocking region is the dynamically triggered region in the virtual environment, the visual blocking region may be dynamically triggered by the virtual object or the virtual item. Exemplarily, when the location of the virtual object is the target location, a visual blocking region with the target location as a center is triggered. Exemplarily, when the virtual object uses the virtual item, a visually triggered region is dynamically triggered with a throwing location of the virtual item in the virtual environment as a center. Exemplarily, when the virtual object uses the virtual item, an area of the visually triggered region is dynamically determined according to a usage situation of the virtual item in the virtual environment. Exemplarily, the longer usage duration of the virtual item, the greater the area of the visually triggered region. Exemplarily, the shorter the usage duration of the virtual item, the less the area of the visually triggered region.

In some embodiments, the virtual environment may include the visual blocking region, and the visual blocking region may completely visually block the virtual element located in the visual blocking region. When the visual blocking region can completely visually block a virtual element located in the visual blocking region, a virtual object located outside the visual blocking region absolutely cannot see any virtual element in the visual blocking region, and certainly, absolutely cannot see the first virtual object located in the visual blocking region.

In some embodiments, the virtual element in the region refers to a virtual element existing before the visual blocking region appears in the region. Exemplarily, the virtual element includes a virtual object, a virtual environment, a virtual vehicle, etc. Exemplarily, the virtual element is a movable element, or may be an immovable element.

In some embodiments, the first virtual object is a virtual object located in the visual blocking region, and the second virtual object is a virtual object located outside the visual blocking region. Thus, when the first virtual object is located in the visual blocking region, the second virtual object cannot see the first virtual object. To be specific, the first virtual object is not displayed in the client (such as the client introduced above) that controls the second virtual object.

In some embodiments, the first virtual object and the second virtual object are both virtual objects located in the visual blocking region. In some embodiments, when the first virtual object and the second virtual object are both located in the visual blocking region and a distance between the first virtual object and the second virtual object is greater than or equal to a second threshold, in an angle of view of the second virtual object, the first virtual object is still completely blocked by the visual blocking region.

In some embodiments, the visual blocking region has no preventing effect or blocking effect on an attack operation, but may visually prevent another virtual object from observing a virtual object in the visual blocking region, to prevent a virtual object outside the visual blocking region from performing an attack operation on a virtual object in the visual blocking region.

In some embodiments, the sound-generating event refers to an event of sound-generating and having a corresponding playable sound effect. In some embodiments, the sound-generating event may be a location change event, such as a creeping event, a walking event, a running event, a jumping event, a climbing event, a vehicle driving event, or a swimming event. In some embodiments, the sound-generating event may alternatively be an attack event, such as a strike event (that is, a strike with no attack item and with naked fists) or a shooting event. In some embodiments, the sound-generating event may alternatively be a touch event, such as an event that the first virtual object collides with or rubs against another virtual element (such as a stone, a desk, a chair, a building, a stack, the ground, or another virtual object other than the first virtual object) in a virtual environment. For example, if the first virtual object is a game character and collides with a wall, the first virtual object triggers a sound-generating event of colliding with a wall, and a sound effect that the first virtual object collides with the wall is required to be played. For another example, the first virtual object is a virtual throwing item (such as a virtual grenade). When the virtual throwing item falls onto the ground and collides with the ground, the virtual throwing item triggers a sound-generating event of colliding with the ground, and a sound effect of the sound-generating event is required to be played.

In some embodiments, one or at least two sound-generating events exist. Exemplarily, at the same moment, only one sound-generating event is allowed to be triggered for the same virtual object. Exemplarily, at the same moment, at least two sound-generating events are allowed to be triggered for the same virtual object. Exemplarily, when each of the at least once sound-generating event, reduction processing is required to be performed, and a sound effect after the reduction processing is played. Exemplarily, each time one sound-generating event is triggered, a sound effect of the sound-generating event after reduction processing is played.

In some embodiments, different quantities of sound-generating events correspond to different quantities of sound effects after reduction processing.

In a first case, one sound-generating event exits. Exemplarily, one sound effect of the sound-generating event after the reduction processing exits. In this case, reduction processing is performed on an initial sound effect corresponding to the sound-generating event, and a sound effect of the sound-generating event after the reduction processing is obtained.

In a second case, at least two sound-generating events exist. Exemplarily, at least two sound effects of the sound-generating events after the reduction processing exist. In this case, reduction processing is performed on the at least two sound-generating events, and sound effects of the at least two sound-generating events after the reduction processing are obtained. Exemplarily, a quantity of sound effects after reduction processing is the same as a quantity of sound-generating events.

In a third case, at least two sound-generating events exist. Exemplarily, one sound effect of the sound-generating events after the reduction processing exists. In this case, reduction processing is performed on the at least two sound-generating events, and one sound effect corresponding to the at least two sound-generating events after the reduction processing is obtained. Exemplarily, a quantity of sound effects after reduction processing is different from a quantity of sound-generating events. In this case, at least two sound-generating events correspond to a mixed sound effect. Exemplarily, reduction processing is performed on the mixed sound effect, and a sound effect after the reduction processing is obtained. Exemplarily, sound effects corresponding to the at least two sound-generating events respectively are obtained and mixed, and the mixed sound effect is obtained. Exemplarily, a mixed sound effect corresponding to at least two sound-generating events is preset in advance, and the mixed sound effect is configured for indicating sound effects corresponding to the at least two sound-generating events respectively.

In some embodiments, if the sound-generating location is in the visual blocking region (that is, the first virtual object is located in the visual blocking region), to obtain a sound effect played by a client corresponding to a second virtual object, reduction processing is required to be performed on an initial sound effect of the sound-generating event. Thus, a sound effect of the sound-generating event after the reduction processing is obtained. To be specific, a sound effect that is required to be played by the client is obtained. Then, the client plays the sound effect of the sound-generating event after the reduction processing. In some embodiments, the reduction processing may alternatively be referred to as blurring processing. To be specific, determination of a location of a virtual object is blurred through a sound effect after the blurring processing.

In some embodiments, the reduction processing may be completed in advance, and a sound effect after the reduction processing is taken as a preset sound effect. When the first virtual object triggers a sound-generating event in the visual blocking region, a corresponding preset sound effect is directly found, and the sound effect after the reduction processing is played.

In some embodiments, the reduction processing may be completed in real time. When the first virtual object triggers a sound-generating event in the visual blocking region, after the sound-generating event is triggered, reduction processing is performed on a sound effect corresponding to the sound-generating event.

In some embodiments, the above reduction processing may be performed by the client introduced above, or may be performed by the background server introduced above. This is not specifically limited in the embodiments of present disclosure. For a specific explanation and description of the reduction processing, reference can be made to content of the following embodiments. Details are not repeated herein.

In some embodiments, a real-time location (including time and object location coordinates) of the first virtual object is acquired. Exemplarily, a real-time location (including time and region location coordinates) of the visual blocking region is acquired. Exemplarily, time when the first virtual object triggers a sound-generating event is acquired. Exemplarily, according to real-time locations corresponding to the first virtual object and the first visual blocking region respectively and the time when the first virtual object triggers the sound-generating event, whether the first virtual object is located in the visual blocking region in the virtual environment and whether the first virtual object triggers the sound-generating event in the visual blocking region are determined.

In some embodiments, the visual blocking region includes an effective region of smoke generated by a virtual smoke apparatus in the virtual environment, or referred to as a coverage region. A central point of a bottom surface of the coverage region is a location at which the virtual smoke apparatus generates the smoke. Exemplarily, the coverage region of the smoke is greater than or equal to the effective region of the smoke. Exemplarily, an edge location of the coverage region of the smoke is considered as a non-effective region of the smoke. Exemplarily, the effective region corresponding to the coverage region of the smoke is set in advance. Exemplarily, an entire coverage region of the smoke is considered as the effective region of the smoke. Exemplarily, a portion of the entire coverage region of the smoke is considered as the effective region of the smoke. Exemplarily, in the entire coverage region of the smoke, a region in which a distance from a center of the entire coverage region to the edge location of the entire coverage region is greater than or equal to a preset value is taken as the effective region of the smoke.

In some embodiments, the virtual smoke apparatus may be a smoke bomb. The smoke bomb is an item which can generate smoke after detonation. The smoke generated by the smoke bomb diffuses into space of the virtual environment, such that the above coverage region is formed. In some embodiments, the smoke bomb may be detonated by the first virtual object or another virtual object in a team to which the first virtual object belongs. In some embodiments, the second virtual object may be a virtual object in a team to which the first virtual object belongs, or may be a virtual object having a competitive relationship or an adversarial relationship with the first virtual object. This is not specifically limited in the embodiments of present disclosure. In some embodiments, the coverage region may be a region in any shape such as a cuboid, a sphere, a hemisphere, or a cylinder. In some embodiments, as shown in FIG. 4, when the coverage region is in a shape of the cuboid, a length (which may be denoted as X), a width (which may be denoted as Y), and a height (which may be denoted as Z) of the coverage region may be configured through a smoke bomb configuration interface 40. For example, the length, the width, and the height of the coverage region may be configured as 600 cm, 600 cm, and 300 cm respectively.

The shape of the coverage region may be specifically set by a person skilled in the art, and is not specifically limited in the embodiments of present disclosure.

In some embodiments, when the visual blocking region includes the above coverage region, operation 320 may be replaced with an operation: play, when the first virtual object is located in a coverage region of smoke in the virtual environment and the first virtual object triggers at least once sound-generating event in the coverage region, a sound effect of the at least once sound-generating event after reduction processing, the coverage region being configured for visually blocking a virtual element in the region, and the reduction processing being configured for reducing an effect of the sound effect in distinguishing a location of the first virtual object.

In some embodiments, the visual blocking region may alternatively be a region in the virtual environment in which fog diffuses, may be a region in the virtual environment in which a sandstorm exits, may be a region in the virtual environment in which no light or dark light exists, or may be a region in the virtual environment in which it rains. This is not specifically limited in the embodiments of present disclosure.

In conclusion, according to the technical solutions provided in the embodiments of present disclosure, when a virtual object is located in a visual blocking region of a virtual environment, reduction processing is performed on a sound effect of a sound-generating event triggered by the virtual object in the visual blocking region, such that an effect of a played sound effect after the reduction processing in distinguishing a sound-generating location is reduced. Considering that visual blocking (such as existence of an obstacle) may block sound propagation (the obstacle reflects, refracts, etc. a sound), visual blocking and auditory sound effect reducing are organically combined such that a more realistic sound effect in a visual blocking situation can be simulated. Diversity of played sound effects is enhanced, a user is provided with immersive experience, and battle experience of the user is improved. The sound effect is merely reduced rather than completely canceled, and the location of the first virtual object can still be sensed based on the sound effect. In addition, through the played sound effect after the reduction processing, the location of the first virtual object is more difficult to distinguish. Forms of human-computer interactions are enriched and game interest is improved while richness of sound effects is improved. In addition, in the embodiments of present disclosure, the visual blocking region can visually block a virtual object located in the visual blocking region, and a location of the virtual object can be auditorily blurred through the reduction processing on the sound effect. Thus, functions of the visual blocking region are enriched.

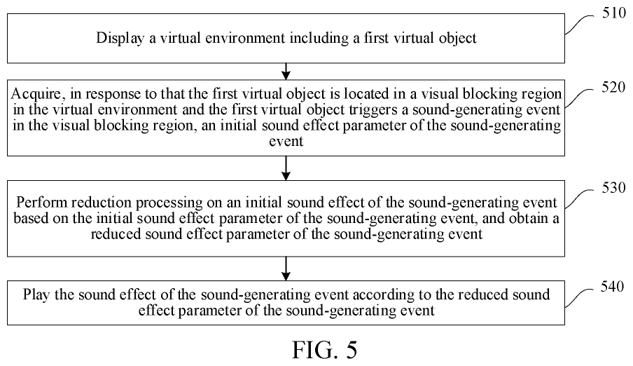

With reference to FIG. 5, a flowchart of a method for playing a sound effect according to another embodiment of present disclosure is shown. In the embodiment, an example in which the method is applied to the client introduced above is taken for description. The method may include at least one of the following operations (510 to 540).

Operation 510: Display a virtual environment interface including a first virtual object.

Operation 510 is similar to or the same as operation 310 in the embodiment shown in FIG. 3 above, and is not repeated herein.

Operation 520: Acquire, when the first virtual object is located in a visual blocking region in the virtual environment and the first virtual object triggers a sound-generating event in the visual blocking region, an initial sound effect parameter of the sound-generating event.

In some embodiments, after the first virtual object triggers the sound-generating event in the visual blocking region, a sound effect parameter corresponding to an initial sound effect of the sound-generating event is acquired. To be specific, an initial sound effect parameter of the sound-generating event is acquired. In some embodiments, the sound effect parameter is a parameter that is required to be used when a sound of the sound-generating event is played, and includes at least one of a volume value, a spatial parameter, an audio value, and a timbre. In some embodiments, initial sound effects corresponding to different sound-generating events may be the same or not. The initial sound effect of the sound-generating event is a sound effect correspondingly played in a normal situation of the sound-generating event, and may alternatively be referred to as a basic sound effect of the sound-generating event. In some embodiments, for the client corresponding to the second virtual object, the initial sound effect parameter of the sound-generating event triggered by the first virtual object is determined according to a type of the sound-generating event, and a relative location relationship between the sound-generating location of the sound-generating event and the second virtual object (that is, a relative location relationship between the first virtual object and the second virtual object). In some embodiments, each of the at least once sound-generating event has an initial sound effect parameter corresponding to the second virtual object. In some embodiments, an initial sound effect parameter of each sound-generating event may include a plurality of parameters.

In some embodiments, the initial sound effect parameter of the sound-generating event may be determined by the client, or may be determined by the background server. This is not specifically limited in the embodiments of present disclosure. Exemplarily, the initial sound effect parameter of the sound-generating event is pre-stored in the terminal device or the server. In some embodiments, if the initial sound effect parameter of the sound-generating event is determined by the background server, after the background server determines the initial sound effect parameter of the sound-generating event, the background server may transmit the initial sound effect parameter of the sound-generating event to the client, and the client performs operation 530.

Operation 530: Perform the reduction processing on an initial sound effect of the sound-generating event based on the initial sound effect parameter of the sound-generating event, and obtain a reduced sound effect parameter of the sound-generating event.

In some embodiments, the initial sound effect of the sound-generating event is spatially three-dimensional. To be specific, the user can distinguish a sound-generating location of the sound-generating event according to the initial sound effect of the sound-generating event, that is, distinguish a location at which the first virtual object triggers the sound-generating event. The initial sound effect of the sound-generating event has a relatively excellent effect in distinguishing the sound-generating location of the sound-generating event.

To improve a blocking degree and a blocking effect of the visual blocking region on a virtual object (such as the first virtual object) located in the visual blocking region, when the sound-generating event triggered by the first virtual object falls within the visual blocking region, the initial sound effect parameter of the sound-generating event triggered by the first virtual object may be adjusted (that is, subjected to reduction processing), and the sound effect of the sound-generating event after the reduction processing is obtained. An effect of the initial sound effect of the sound-generating event in distinguishing the sound-generating location of the sound-generating event (that is, an effect of distinguishing the location of the first virtual object) is greater than an effect of the sound effect of the sound-generating event after the reduction processing in distinguishing the sound-generating location of the sound-generating event. Thus, an effect and an action of a finally played sound effect on positioning the first virtual object are reduced. A difficulty in determining the first virtual object by a user corresponding to the second virtual object through a sound effect of at least once sound-generating event is increased.

In some embodiments, operation 520 and operation 530 may be performed by the client, and may alternatively be performed by the background server introduced above. In some embodiments, operation 520 and operation 530 may alternatively be performed by the client and the server separately. For example, operation 520 is performed by the server, and operation 530 is performed by the client.

In some embodiments, reduction processing is performed on an initial sound effect corresponding to a first sound-generating event of the at least once sound-generating event, and a reduced sound effect parameter corresponding to the first sound-generating event is obtained. Exemplarily, the first sound-generating event is any one of the at least once sound-generating event.

In some embodiments, operation: perform reduction processing on an initial sound effect corresponding to the sound-generating event, and obtain a reduced sound effect parameter corresponding to the sound-generating event includes at least one of the following: perform the reduction processing on a volume value of the initial sound effect corresponding to the sound-generating event, and obtain a reduced volume value corresponding to the sound-generating event; perform the reduction processing on a spatial parameter of the initial sound effect corresponding to the sound-generating event, and obtain a reduced spatial parameter corresponding to the sound-generating event; perform the reduction processing on an audio value of the initial sound effect corresponding to the sound-generating event, and obtain a reduced audio value corresponding to the sound-generating event; and perform the reduction processing on a timbre of the initial sound effect corresponding to the sound-generating event, and obtain a reduced timbre corresponding to the sound-generating event.

Operation 540: Play the sound effect of the sound-generating event according to the reduced sound effect parameter of the sound-generating event.

In some embodiments, the reduced sound effect parameter includes at least one of a reduced volume value, a reduced spatial parameter, a reduced audio value, and a reduced timbre.

In some embodiments, the sound effect of the sound-generating event is played according to one or more of the reduced volume value, the reduced spatial parameter, the reduced audio value, and the reduced timbre of the sound-generating event. In some embodiments, the sound effect of the sound-generating event is played according to the reduced volume value of the sound-generating event. In some embodiments, the sound effect of the sound-generating event is played according to the reduced spatial parameter of the sound-generating event. In some embodiments, the sound effect of the sound-generating event is played according to the reduced audio value of the sound-generating event. In some embodiments, the sound effect of the sound-generating event is played according to the reduced timbre of the sound-generating event.

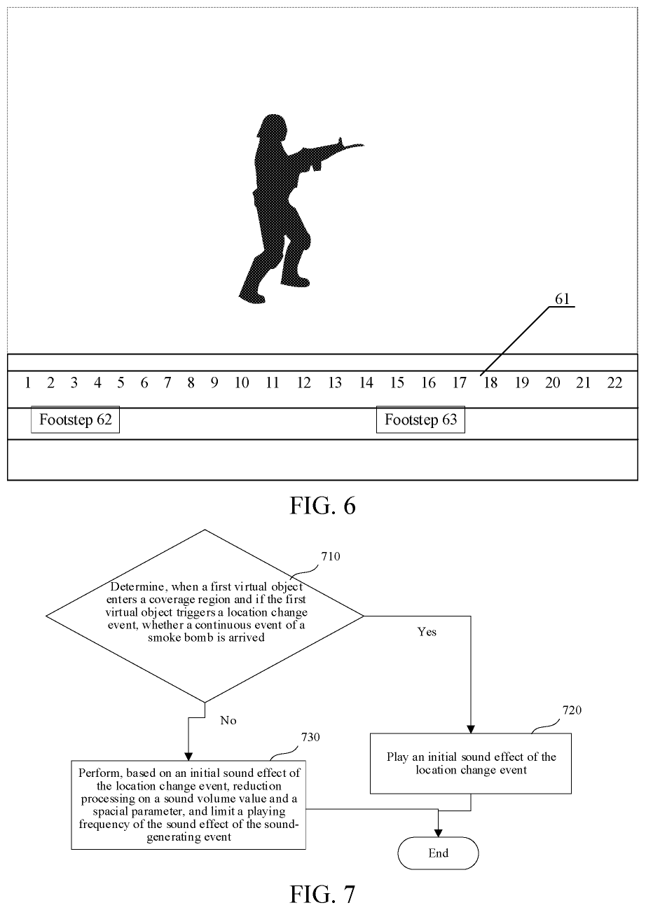

In some embodiments, the sound-generating event is directly configured on a timeline of an animation file of a movement of the first virtual object. As shown in FIG. 6, if the sound-generating event is a location change, each time the first virtual object moves, a footstep event, such as a footstep event corresponding to a footstep 62 or a footstep event corresponding to a footstep 63, of playing a corresponding sound effect on a timeline 61 is synchronously triggered.

In conclusion, according to the technical solutions provided in the embodiments of present disclosure, reduction processing is performed on an initial sound effect of a sound-generating event, such that an effect and an action of a finally played sound effect on positioning a first virtual object are reduced.

In addition, through the reduction processing, a difficulty in determining the first virtual object by the user corresponding to the second virtual object through the sound effect of the sound-generating event is further increased. Then, a blocking effect of the visual blocking region on a virtual object located in the visual blocking region is improved.

In some embodiments, the sound effect parameter includes a volume value. Operation 530 may include: determine, based on an initial volume value of a first sound-generating event of the at least once sound-generating event, a reduced volume value of the first sound-generating event, the reduced volume value of the first sound-generating event being less than the initial volume value of the first sound-generating event. In some embodiments, based on the initial volume value of the sound-generating event, the reduced volume value of the sound-generating event is determined. The reduced volume value of the sound-generating event is less than the initial volume value of the sound-generating event.

In some embodiments, if a sound-generating location of the first sound-generating event is in the visual blocking region, the volume value of the sound effect of the first sound-generating event is reduced based on the initial volume value of the first sound-generating event. Thus, the reduced volume value of the first sound-generating event is obtained.

In some embodiments, the volume value may alternatively be referred to as a loudness value. In some embodiments, a unit of the volume value is decibel (dB). In some embodiments, the initial volume value of the first sound-generating event is reduced according to a set volume difference. To be specific, the reduced volume value of the first sound-generating event can be obtained by subtracting the volume difference from the initial volume value of the first sound-generating event. In some embodiments, the volume difference may be 3 dB, 4 dB, etc. Certainly, the volume difference may alternatively be another value. A specific value of the volume difference may be set by a person skilled in the art according to an actual situation. This is not specifically limited in the embodiments of present disclosure.

In some embodiments, the sound-generating event can be obtained by reducing the initial volume value of the sound-generating event according to a set volume reducing amplitude. Exemplarily, the set volume reducing amplitude is K. Then, a result obtained by subtracting a product of the initial volume value of the sound-generating event and the set volume reducing amplitude K from the initial volume value of the sound-generating event is the reduced volume value of the sound-generating event. Specifically, K is a non-negative number.

In some embodiments, the sound-generating event can be obtained by reducing the initial volume value of the sound-generating event according to a set reducing coefficient. Exemplarily, the set reducing coefficient is W. Then, a result obtained by multiplying the initial volume value of the sound-generating event by the set reducing coefficient W is the reduced volume value of the sound-generating event. Specifically, W is a non-negative number.

In the above implementation, the reduction processing is performed on the sound effect of the sound-generating event by reducing the volume value, such that a volume of the finally played sound effect is reduced. To be specific, auditory clarity of the sound effect is reduced. Since a capability of distinguishing a sound by human ears is reduced due to reduction of the volume, an effect of the sound effect in distinguishing the location of the first virtual object is reduced.

In some embodiments, the sound effect parameter include a spatial parameter. Operation 530 may include: determine, based on an initial spatial parameter of a first sound-generating event of at least once sound-generating event, a reduced spatial parameter of the first sound-generating event, an effect of the reduced spatial parameter in distinguishing a direction and a distance of a sound-generating location being less than an effect of the initial spatial parameter in distinguishing the direction and the distance of the sound-generating location. In some embodiments, the reduced spatial parameter of the sound-generating event is determined based on the initial spatial parameter of the sound-generating event. An effect of the reduced spatial parameter in distinguishing a direction and a distance of a sound-generating location is less than an effect of the initial spatial parameter in distinguishing the direction and the distance of the sound-generating location.

In some embodiments, since the virtual environment is merely a simulated real world, the first sound-generating event does not really occur. Actually, a sound effect of the first sound-generating event is played by a built-in audio playing apparatus of the terminal device or an external audio playing device of the terminal device. The spatial parameter may be configured for simulating a direction and a distance of the sound-generating location relative to the second virtual object in the virtual environment. In some embodiments, the spatial parameter of the initial sound effect of the first sound-generating event has a relatively excellent effect in distinguishing the direction and the distance of the first sound-generating location relative to the second virtual object. Thus, during the reduction processing, an effect of the sound effect in distinguishing the direction and the distance of the first sound-generating location relative to the second virtual object can be reduced by adjusting the spatial parameter. Then, sensing and determination of a user on the location of the first virtual object according to a sound effect played corresponding to the first sound-generating event are blurred.

In some embodiments, the spatial parameter refers to a parameter that can affect positioning, propagation, and sensing of a sound in virtual space. In some embodiments, the spatial parameter includes at least one of a direction (a sound may be located in different directions, including an upper direction, a lower direction, and a surrounding direction. How a player hears a sound from each direction is simulated. This helps the player determine a source of a sound and a location of an enemy in a game), a distance (representation of a sound can cause the player to sense a distance of the sound, such that layering of a sound effect is improved. In a game, this is generally implemented by adjusting parameters such as a volume, pitch, or a delay of a sound, to simulate a natural phenomenon of reduction of a sound with a distance), a dynamic movement (a sound may dynamically change, to create a feeling of sound movement. This helps simulate a sound effect when an object moves or characters interact in a game, to enhance a sense of reality of the game), space reverberation (reflection and reducing effects when a sound is propagated in indoor or outdoor space are simulated. This can be implemented by adding a reverberation effect or adjusting a reverberation parameter, to create a more vivid game environment), a three-dimensional sound effect setting (many games support a three-dimensional sound effect, and this allows a sound to be positioned and propagated in a three-dimensional space. The related spatial parameter may include coordinates of a sound in a three-dimensional space, a diffusion angle, a sound reduction speed, etc., and these parameters can precisely control a location and a propagating mode of the sound in a game world), and a Doppler effect (when a relative movement exists between a sound source and a listener, a sound frequency sensed by a listener changes, and this is the Doppler effect. In a game, a sense of reality of a sound can be enhanced by simulating this effect, especially of a sound produced by a moving object such as a vehicle or an aircraft). Some parameters related to sound effect playing and management, such as a format, quality, or a loading mode of a sound file exits. These parameters do not directly belong to the spatial parameter, but affect sound effect experience in a game.

In some embodiments, the reduced spatial parameter of the first sound-generating event is determined based on the initial spatial parameter of the first sound-generating event. Exemplarily, reduction processing is performed on at least one of the direction, the distance, the space reverberation, the three-dimensional sound effect setting, and the Doppler effect of the initial spatial parameter of the first sound-generating event, and the reduced spatial parameter of the first sound-generating event is obtained. Exemplarily, at least one of the direction, the distance, the space reverberation, the three-dimensional sound effect setting, and the Doppler effect of the initial spatial parameter of the first sound-generating event is deleted, and the reduced spatial parameter of the first sound-generating event is obtained. Exemplarily, at least one of the direction, the distance, the space reverberation, the three-dimensional sound effect setting, and the Doppler effect of the initial spatial parameter of the first sound-generating event is reduced, and the reduced spatial parameter of the first sound-generating event is obtained.

In some embodiments, the spatial parameter includes a time difference and a volume difference between respective sound effects of at least two sound channels. Operation: determine, based on the initial spatial parameter of the first sound-generating event, a reduced spatial parameter of the first sound-generating event includes: determine, based on an initial time difference or an initial volume difference between the respective sound effects of the at least two sound channels of the first sound-generating event, a reduced time difference or a reduced volume difference of the first sound-generating event.

In some embodiments, based on the initial time difference or the initial volume difference between the respective sound effects of the at least two sound channels of the sound-generating event, the reduced time difference or the reduced volume difference of the sound-generating event is determined.

In some embodiments, the sound effect of the first sound-generating event includes tracks of a plurality of sound channels, and each track may be played by a corresponding channel. For example, the first sound-generating event may correspond to a track of a left sound channel and a track of a right sound channel. In some embodiments, a time difference and a volume difference between a plurality of sound channels included in the spatial parameter may be configured for simulating an effect that a sound of a first sound-generating event generated at a corresponding location is propagated to two ears of a second virtual object. Thus, by adjusting an initial time difference or an initial volume difference between the respective sound effects of the plurality of sound channels, an effect of the sound effect in distinguishing the location of the first virtual object can be reduced, and reduction processing on the sound effect of the sound-generating event is implemented.

In some embodiments, the reduced spatial parameter of the first sound-generating event is obtained by adjusting the initial spatial parameter of the first sound-generating event. In some embodiments, the reduced spatial parameter of the first sound-generating event is obtained by adjusting subparameters (such as the time difference or the volume difference) included in the spatial parameter of the first sound-generating event separately. In some embodiments, the spatial parameter is an encapsulated parameter and is configured for influencing an effect of an audio expression sound source location. Values of adjusted subparameters can be automatically determined by adjusting only one corresponding parameter value of the spatial parameter. For example, a reduced time difference or a reduced volume difference of the first sound-generating event is determined. In some embodiments, a parameter value corresponding to the initial spatial parameter is a first parameter value, and a parameter value of a reduced spatial parameter is a second parameter value. Exemplarily, the first parameter value is greater than the second parameter value. Exemplarily, the second parameter value is set by a developer or a user. Exemplarily, the user can drag a slide for adjustment, to obtain a specific value of the second parameter value. For example, the initial spatial parameter of the first sound-generating event may be denoted as 3D Spatialization and may be set as 100%, and the reduced spatial parameter (that is, adjusted 3D Spatialization) of the first sound-generating event may be set as 50%.

In some embodiments, based on the initial time difference or the initial volume difference between the respective sound effects of the at least two sound channels of the sound-generating event, the reduced time difference or the reduced volume difference of the sound-generating event is determined. Exemplarily, an initial time difference between respective sound effects of a first sound channel and a second sound channel of the at least two sound channels is obtained. The first sound channel and the second sound channel are any two different sound channels of the at least two sound channels. Exemplarily, the initial time difference between the respective sound effects of the first sound channel and the second sound channel is reduced, and the reduced time difference is obtained. Exemplarily, a reducing amplitude of the time difference is a preset value or ratio. Exemplarily, an initial volume difference between respective sound effects of a first sound channel and a second sound channel of the at least two sound channels is obtained. The first sound channel and the second sound channel are any two different sound channels of the at least two sound channels. Exemplarily, the initial volume difference between the respective sound effects of the first sound channel and the second sound channel is reduced, and the reduced volume difference is obtained. Exemplarily, a reducing amplitude of the volume difference is a preset value or ratio. Exemplarily, a reduced time difference or a reduced volume difference of the sound-generating event is taken as a reduced spatial parameter of the sound-generating event.

In the above implementation, by adjusting the spatial parameter, expressiveness of a sound effect of a sound-generating event for a sound-generating location is blurred to some extent. Further, an effect of the sound effect in distinguishing the location of the first virtual object is reduced.

In addition, by reducing an initial time difference or an initial volume difference between respective sound effects of at least two sound channels of the sound-generating event, a reduced time difference or a reduced volume difference of the sound-generating event is determined and taken as the reduced spatial parameter of the sound-generating event. Diversity and flexibility of reducing modes for spatial parameters are embodied. Reduction processing on the spatial parameter is facilitated, and reducing efficiency of the spatial parameter is ensured.

In some embodiments, operation 530 may include: determine, based on frequency limitation information corresponding to the visual blocking region, whether a first sound-generating event of the at least once sound-generating event belongs to a sound effect playing event or a sound effect hiding event, the frequency limitation information being configured for limiting a playing frequency of the sound effect of the sound-generating event, the sound effect playing event being a sound-generating event of playing a corresponding sound effect, and the sound effect hiding event being a sound-generating event of hiding the corresponding sound effect. In some embodiments, operation 540 may include: play a sound effect of the first sound-generating event when the first sound-generating event belongs to the sound effect playing event; and hide the sound effect of the first sound-generating event when the first sound-generating event belongs to the sound effect hiding event.

In some embodiments, based on frequency limitation information corresponding to the visual blocking region, whether the sound-generating event belongs to a sound effect playing event or a sound effect hiding event is determined. The frequency limitation information is configured for limiting a playing frequency of the sound effect of the sound-generating event. The sound effect playing event is a sound-generating event of playing a corresponding sound effect. The sound effect hiding event is a sound-generating event of hiding the corresponding sound effect. When the sound-generating event belongs to the sound effect playing event, the sound effect of the sound-generating event is played. When the sound-generating event belongs to the sound effect hiding event, the sound effect of the sound-generating event is not played.

In some embodiments, the visual blocking region limits the playing frequency of the sound effect of the sound-generating event. To be specific, a corresponding sound effect is not played for each sound-generating event. In cases of some sound-generating events, the client corresponding to the second virtual object does not play any corresponding sound effect. A sound-generating event that a corresponding sound effect is required to be played according to the frequency limitation information belongs to the sound effect playing event. A sound-generating event (that is, a sound-generating event of playing no sound effect) that a corresponding sound effect is required to be hidden according to the frequency limitation information belongs to the sound effect hiding event.

In some embodiments, operation: determine, based on frequency limitation information corresponding to the visual blocking region, whether a first sound-generating event belongs to a sound effect playing event or a sound effect hiding event may be performed by the client or may be performed by the server. This is not specifically limited in the embodiments of present disclosure.

In some embodiments, the frequency limitation information includes at least one of the following:
1. Within first duration, a quantity of sound effect playing events is less than or equal to a first threshold.

In some embodiments, the playing frequency of the sound effect of the sound-generating event is limited by limiting a quantity of sound-generating events that can be determined as sound effect playing events within the first duration. In some embodiments, when a quantity of sound-generating events triggered within the first duration is less than or equal to the first threshold, all the sound-generating events triggered within the first duration are sound effect playing events, and corresponding sound effects are required to be played. When the quantity of sound-generating events triggered within the first duration is greater than the first threshold, in a trigger time sequence, a first threshold quantity of sound-generating events triggered first within the first duration belong to sound effect playing events, and all sound-generating events after the first threshold is exceeded within the first duration belong to sound effect hiding events. For example, the frequency limitation information includes: when the first virtual object is located in the visual blocking region, only footsteps (that is, sound effects) of twice location changes (that is, sound-generating events are triggered) of the first virtual object are allowed to be played within 5 s. Then, within the 5 s, the first time of location change and the second time of location change of the first virtual object belong to sound effect playing events, and footsteps corresponding to the first time of location change and the second time of location change of the first virtual object respectively are required to be played. Within the 5 s, footsteps of a third time of location change and location changes after the third time of location change are not played. To be specific, the user corresponding to the second virtual object cannot hear the footsteps of the third time of location change and the location changes after the third time of location change.
2. Every n continuous sound-generating events include m sound-generating events that belong to sound effect playing events, n and m are integers greater than 1, and m is less than n.

In some embodiments, whether the sound-generating event triggered by the first virtual object belongs to the sound effect playing event is determined according to a rule.

In some embodiments, first m sound-generating events of every n continuous sound-generating events are determined to belong to sound effect playing events, and sound-generating events of the n continuous sound-generating events after the m sound-generating events are determined to belong to sound effect hiding events. For example, if n is 2 and m is 1, in a trigger time sequence, the at least once sound-generating event are: a sound effect playing event and a sound effect hiding event; a sound effect playing event and a sound effect hiding event; a sound effect playing event and a sound effect hiding event...

In some embodiments, last m sound-generating events of every n continuous sound-generating events are determined to belong to sound effect playing events, and sound-generating events of the n continuous sound-generating events before the m sound-generating events are determined to belong to sound effect hiding events. For example, if n is 5 and m is 3, in a trigger time sequence, the at least once sound-generating event are: a sound effect playing event, a sound effect playing event, a sound effect hiding event, a sound effect hiding event, and a sound effect hiding event; a sound effect playing event, a sound effect playing event, a sound effect hiding event, a sound effect hiding event, and a sound effect hiding event.
3. The sound effect playing event or the sound effect hiding event is randomly determined.

In some embodiments, whether each sound-generating event belongs to the sound effect playing event or the sound effect hiding event can be determined through a random model. For example, when a sound-generating event A, if output of the random model is “1”, it indicates that the sound-generating event A belongs to the sound effect playing event. If the output of the random model is “0”, it indicates that the sound-generating event A belongs to the sound effect hiding event.

In the above implementation, by limiting a playing frequency of a sound effect, a quantity of sound-generating events of which corresponding sound effects are played is less than a quantity of sound-generating events that are actually triggered by the virtual object. Thus, exposure by the first virtual object of sound-generating events triggered by the first virtual object is reduced. Another virtual object (such as the second virtual object) can determine a location or a moving path of the first virtual object only through a relatively small quantity of sound effects. Thus, a blocking effect of the visual blocking region on the first virtual object is enhanced.

In some embodiments, as shown in FIG. 7, with an example in which the visual blocking region is a coverage region of smoke generated by a smoke bomb, the method may further include the following operations:
operation 710: determine, when a first virtual object enters a coverage region and if the first virtual object triggers a location change event, whether a continuous event of a smoke bomb is arrived; if yes, perform operation 720; and if no, perform operation 730;
operation 720: play an initial sound effect of the location change event; and
operation 730: reduce, based on an initial sound effect of the location change event, a volume value and a spatial parameter, and limit a playing frequency of the sound effect of the sound-generating event.

In some embodiments, the visual blocking region includes at least two subregions having different visual blocking degrees, and visual blocking degrees of different locations in the same subregion are the same. Operation: play a sound effect of the sound-generating event after reduction processing (that is, operation 320) may include: play, when the sound-generating location of the sound-generating event is in a first subregion of the at least two subregions and based on a visual blocking degree of a first subregion, the sound effect of the sound-generating event after the reduction processing; a reducing effect of the sound effect of the sound-generating event after the reduction processing in distinguishing the location of the first virtual object having a positive correlation with the visual blocking degree. In some embodiments, when the sound-generating location of the sound-generating event is in the first subregion of the at least two subregions, the sound effect of the sound-generating event after the reduction processing is determined based on the visual blocking degree of the first subregion. A reducing effect of the sound effect of the sound-generating event after the reduction processing in distinguishing the location of the first virtual object has a positive correlation with the visual blocking degree.

In some embodiments, the visual blocking region includes at least two subregions. Visual blocking degrees of the same subregion are the same at every locations, and visual blocking degrees of different subregions may be different. In some embodiments, the visual blocking degree is configured for indicating a blocking effect on an element in the visual blocking region. In some embodiments, a subregion having a higher visual blocking degree has a better reducing effect on the sound effect of the sound-generating event. A subregion having a lower visual blocking degree has a poorer reducing effect on the sound effect of the sound-generating event. To be specific, a subregion having a higher visual blocking degree has a better visual blocking effect on a virtual element located in the subregion and a better reducing effect on the sound effect of the sound-generating event. A subregion having a lower visual blocking degree has a poorer visual blocking effect on a virtual element located in the subregion and a poorer reducing effect on the sound effect of the sound-generating event. Thus, a visual blocking effect of each subregion of the visual blocking region is unified with the reducing effect on the sound effect of the sound-generating event. A visual blocking effect and an auditory blocking effect of the visual blocking region on the first virtual object are coordinated and unified. Moreover, user experience is ensured.

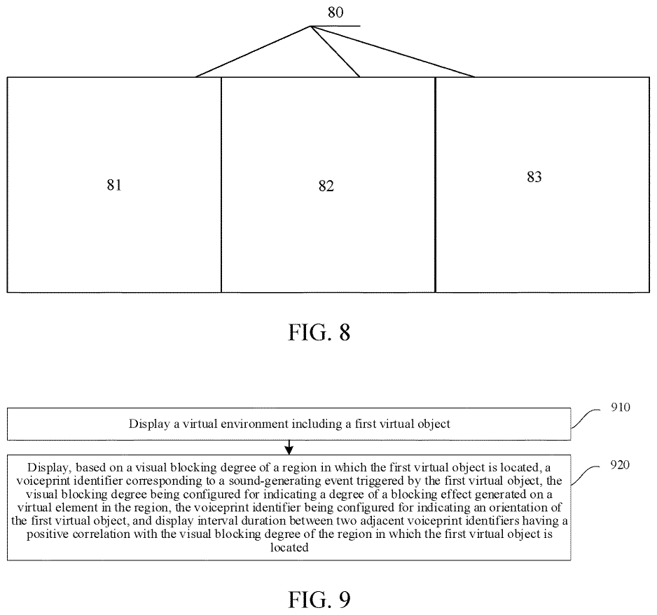

In some embodiments, as shown in FIG. 8, the visual blocking region 80 includes three subregions, which are a subregion 81, a subregion 82, and a subregion 83 respectively. Visual blocking degrees of the subregion 81 and the subregion 83 are the same, and a visual blocking degree of the subregion 82 is greater than that of the subregion 81 and than that of the subregion 83. Thus, a reducing effect of the subregion 81 on a sound effect of a sound-generating event therein and a reducing effect of the subregion 83 on a sound effect of a sound-generating events therein are the same. A reducing effect of the subregion 82 on the sound effect of the sound-generating event therein is greater than that of the subregion 81 and the subregion 83. For example, the visual blocking region 80 is observed from an angle of view of the second virtual object. If the first virtual object is located in the subregion 81 and the subregion 83, a shape of the first virtual object can be vaguely seen. If the first virtual object is located in the subregion 82, the first virtual object absolutely cannot be seen. To be specific, the subregion can completely block the first virtual object located therein. In addition, a volume of a footstep of a location change of the first virtual object in the subregion 82 is less than a volume of a footstep of a location change of the first virtual object in the subregion 81 or the subregion 83.

In some embodiments, when a sound-generating location of a second sound-generating event of the at least once sound-generating event is in a first subregion of the at least two subregions, a sound effect of the second sound-generating event after reduction processing is played based on a visual blocking degree of the first subregion. The reducing effect of the sound effect of the second sound-generating event after the reduction processing in distinguishing the location of the first virtual object has a positive correlation with the visual blocking degree. In some embodiments, the second sound-generating event is any sound-generating event of the at least once sound-generating event.

In some embodiments, a sound-generating location of the second sound-generating event is obtained. Exemplarily, a region in which the sound-generating location of the second sound-generating event is located is determined. Exemplarily, the region in which the sound-generating location of the second sound-generating event falls within is the first subregion of the at least two subregions. Exemplarily, a reducing effect corresponding to the visual blocking degree of the first subregion is determined according to a corresponding relationship between a preset visual blocking degree of the region and a reducing effect. Exemplarily, reduction processing is performed on the initial sound effect of the second sound-generating event according to the reducing effect corresponding to the visual blocking degree of the first subregion, and a sound effect of the second sound-generating event after the reduction processing is obtained. Exemplarily, the reduction processing herein includes at least one of reduction processing on a volume value, reduction processing on a spatial parameter, limitation on a frequency of a sound effect of a sound-generating event, etc. mentioned in the above embodiments. For a specific reduction processing mode, reference can be made to explanations and descriptions in the above other embodiments. Details are not repeated herein.

In some embodiments, the visual blocking degree is configured for indicating a degree of a blocking effect on a virtual element in the region. Exemplarily, the visual blocking degree is configured for indicating a degree of a blocking effect on clarity, brightness, etc. of the virtual element in the region. Exemplarily, different visual blocking degrees correspond to different blocking levels. Exemplarily, the greater the blocking level corresponding to the visual blocking degree, the better the blocking effect on the clarity or brightness of the virtual element in the region, that is, the lower the clarity or brightness of the virtual element in the region displayed on the user interface. In some embodiments, at least two subregions exist in the same visual blocking region, and visual blocking degrees corresponding to the subregions are different. To be specific, blocking levels are different.

In some embodiments, when the visual blocking region is a coverage region of smoke generated by a smoke bomb, the visual blocking degree is determined according to a smoke concentration in each subregion. In some embodiments, the higher the smoke concentration in the subregion, the higher the blocking level corresponding to the visual blocking degree. In some embodiments, the lower the smoke concentration in the subregion, the lower the blocking level corresponding to the visual blocking degree. In some embodiments, the higher the smoke concentration, the higher the visual blocking degree of the corresponding subregion. The lower the smoke concentration, the lower the visual blocking degree of the corresponding subregion. In some embodiments, the smoke concentration may change as time changes. For the same subregion, after the smoke bomb is detonated, the smoke concentration decreases with the passage of time until the smoke completely disappears. Thus, the visual blocking degree of the subregion also changes with time.

In the above implementation, the subregions are divided according to visual blocking degrees. Visual blocking effects and auditory blocking effects of the first virtual object in subregions having different visual blocking degrees are different, such that changes and effects of the visual blocking regions are enriched. In addition, visual blocking effects and auditory blocking effects of the visual blocking regions on the first virtual object are coordinated and unified, such that user experience is improved.

In the embodiments of present disclosure, the visual blocking region includes the coverage region of the smoke, and is a region blocking vision of a virtual object due to the smoke generated by the virtual smoke apparatus. A visual smoke blocking effect and an auditory shielding effect are combined, to provide more realistic battle experience for a user. Forms of human-computer interactions are enriched, and interaction efficiency is improved.

In some embodiments, after operation 320 in the embodiment of FIG. 3, when the first virtual object is moved out of the visual blocking region or the visual blocking region is canceled, if the first virtual object triggers the sound-generating event, an initial sound effect of the sound-generating event is played.

In the above implementation, the first virtual object may move from the visual blocking region to the non-visual blocking region. Alternatively, the visual blocking region may be canceled to become the non-visual blocking region. After the location of the first virtual object does not belong to the visual blocking region, when the sound-generating event is triggered by the first virtual object, playing of the corresponding initial sound effect is resumed. Through a change of the sound effect, another virtual object located nearby the first virtual object can determine the location of the first virtual object more clearly. Thus, richness of game content is improved, and further interest of a user is improved.

In some embodiments, operation: play a sound effect of the at least once sound-generating event after reduction processing (that is, operation 320) may include: play, based on a type of the sound-generating event, a sound effect of the sound-generating event after the reduction processing, reduction processing modes corresponding to different types of sound-generating events are different. In some embodiments, the sound effect of the sound-generating event after the reduction processing is determined based on the type of the sound-generating event. Reduction processing modes corresponding to different types of sound-generating events are different.

In some embodiments, a corresponding relationship between the type of the sound-generating event and the reduction processing mode is set in advance. Exemplarily, the corresponding relationship between the type of the sound-generating event and the reduction processing mode is stored on the server or the terminal device in a form of a table, a static link, a dynamic link, etc.

In some embodiments, an event type of a third sound-generating event of the at least once sound-generating event is acquired. Exemplarily, when the terminal device locally stores the corresponding relationship between the type of the sound-generating event and the reduction processing mode, the reduction processing mode corresponding to the event type of the third sound-generating event is found. Exemplarily, through the reduction processing mode corresponding to the event type of the third sound-generating event, reduction processing is performed on the initial sound effect parameter of the third sound-generating event, and a reduced sound effect parameter is obtained. Exemplarily, a sound effect of the third sound-generating event is played according to the reduced sound effect parameter of the third sound-generating event. Exemplarily, the third sound-generating event is any sound-generating event of the at least once sound-generating event. Exemplarily, when the terminal device does not locally store the corresponding relationship between the type of the sound-generating event and the reduction processing mode, the reduction processing mode corresponding to the event type of the third sound-generating event is acquired from the server, or the corresponding relationship between the type of the sound-generating event and the reduction processing mode is acquired from the server.

In some embodiments, reduction processing modes and processes of different types of sound-generating events may be different. Thus, richness of game content is further improved. By combining the type of the sound-generating event with the reduction processing mode, an association between sound effect reduction processing and the type of the sound-generating event is reflected. Flexibility and diversity of sound effect reducing are further reflected. Further, the user is provided with better auditory experience, and forms of human-computer interactions are enriched.

In some embodiments, when the at least once sound-generating event is a sound-generating event of a location change type, a sound effect of the at least once sound-generating event after first reduction processing is played, and the sound-generating event of the location change type is configured for changing a location of the first virtual object. When the at least once sound-generating event is a sound-generating event of an attack type, a sound effect of the at least once sound-generating event after second reduction processing is played, the sound-generating event of the attack type is configured for attacking a second virtual object in the virtual environment. A reducing degree of the first reduction processing on the sound effect is greater than a reducing degree of the second reduction processing on the sound effect.

In some embodiments, when the sound-generating event is a sound-generating event of a location change type, the sound effect of the sound-generating event after the reduction processing is the sound effect of the sound-generating event after the first reduction processing, and the sound-generating event of the location change type is configured for changing the location of the first virtual object. When the sound-generating event is the sound-generating event of the attack type, the sound effect of the sound-generating event after the reduction processing is the sound effect of the sound-generating event after the second reduction processing, and the sound-generating event of the attack type is configured for attacking the second virtual object in the virtual environment. A reducing degree of the first reduction processing on the sound effect is greater than a reducing degree of the second reduction processing on the sound effect.

In some embodiments, when a third sound-generating event of the at least once sound-generating event is a sound-generating event of a location change type, a sound effect of the third sound-generating event after the first reduction processing is played, and the sound-generating event of the location change type is configured for changing the location of the first virtual object. When the third sound-generating event is the sound-generating event of the attack type, the sound effect of the third sound-generating event after the second reduction processing is played, the sound-generating event of the attack type is configured for attacking the second virtual object in the virtual environment. A reducing degree of the first reduction processing on the sound effect is greater than a reducing degree of the second reduction processing on the sound effect.

In some embodiments, the first reduction processing is a reduction processing mode corresponding to the sound-generating event of the location change type. In some embodiments, the second reduction processing is a reduction processing mode corresponding to the sound-generating event of the attack type. In some embodiments, the first reduction processing and the second reduction processing are two different reduction processing modes which are preset in advance. In some embodiments, the reducing degree of the first reduction processing on the sound effect is greater than the reducing degree of the second reduction processing on the sound effect. In some embodiments, a reducing degree of the first reduction processing on a volume value of the sound effect is greater than a reducing degree of the second reduction processing on a volume value of the sound effect. In some embodiments, a reducing degree of the first reduction processing on a spatial parameter of the sound effect is greater than a reducing degree of the second reduction processing on a spatial parameter of the sound effect. In some embodiments, a frequency limitation of the first reduction processing on the sound effect is greater than a frequency limitation of the second reduction processing on the sound effect.

In the above implementation, through different reducing modes for corresponding sound effects of the sound-generating event of the location change type and the sound-generating event of the attack type, the visual blocking region can have a better blocking effect on the sound effect of the sound-generating event of the location change type, and the visual blocking region has a relatively poor blocking effect on the sound effect of the sound-generating event of the location change type. Thus, an influence of the visual blocking region on a location change is improved, and an attack action of the visual blocking region is limited. Further, abuse by a user of the visual blocking region is reduced, and balance of a battle process or a competition process between virtual objects is improved.

With reference to FIG. 9, a flowchart of a method for displaying a voiceprint identifier according to an embodiment of present disclosure is shown. In the embodiment, an example in which the method is applied to the client introduced above is taken for description. The method may include at least one of the following operations (910 and 920).

Operation 910: Display a virtual environment interface including a first virtual object.

In some embodiments, a virtual object controlled by a user account logged in the client introduced above may be a second virtual object in a virtual environment. The second virtual object and the first virtual object are different virtual objects participating in the same round of game and located in the same virtual environment. The terminal device introduced above is configured to present a virtual environment (including another virtual object in the virtual environment, such as the first virtual object) observed by controlling an angle of view of the second virtual object, and play a sound effect configured for simulating a sound effect heard by the second virtual object in the virtual environment. To be specific, a user can hear a sound effect in the virtual environment by controlling the second virtual object. In some embodiments, the terminal device introduced above may further be configured to display a voiceprint identifier of the sound effect heard from the angle of view of the second virtual object.

For some explanations and descriptions of operation 910, reference can be made to content of operation 310 in the embodiment of FIG. 3. Details are not repeated herein.

Operation 920: Display, based on a visual blocking degree of a region in which the first virtual object is located, a voiceprint identifier corresponding to a sound-generating event triggered by the first virtual object, the visual blocking degree being configured for indicating a degree of a blocking effect produced on a virtual element in the region, the voiceprint identifier being configured for denoting an orientation of the first virtual object, and display interval duration between two adjacent voiceprint identifiers having a positive correlation with the visual blocking degree of the region in which the first virtual object is located.

In some embodiments, the sound-generating event refers to an event of sound-generating and having a corresponding playable sound effect. In some embodiments, when the first virtual object triggers a sound-generating event, a voiceprint identifier of the sound-generating event can be displayed at the same time, to present related information of the sound-generating event in a visual mode, such as location information or sound effect feature information of the sound-generating event. In some embodiments, the location information may include an orientation of a sound-generating location (that is, an orientation in which the first virtual object triggers a corresponding sound-generating event). The sound effect feature information may include a volume or volume change information of a sound effect of the sound-generating event.

In some embodiments, considering that the first virtual object may continuously trigger a plurality of sound-generating events in a short time, for example, continuously trigger a plurality of location change events. In the embodiments of present disclosure, only voiceprint identifiers corresponding to some location change events may be displayed. For example, the voiceprint identifier may be displayed once at intervals of display interval duration. To be specific, within display interval duration after the voiceprint identifier is displayed once, even if the first virtual object triggers the sound-generating event, no voiceprint identifier is displayed. Thus, a displaying frequency of the voiceprint identifier is limited, and the voiceprint identifier is prevented from being displayed excessively frequently.

In some embodiments, the display interval duration has a positive correlation with the visual blocking degree of the region in which the first virtual object is located. To be specific, the higher the visual blocking degree of the region in which the first virtual object is located, the longer the display interval duration. The lower the visual blocking degree of the region in which the first virtual object is located, the shorter the display interval duration. Exemplarily, the display interval duration is configured for indicating a time interval between two displayed adjacent voiceprint identifiers.

In some embodiments, a region in the virtual environment in which smoke or fog exits, a region in which it rains, and a region in which no light or less light exists can limit or prevent a user from visually observing the virtual environment. Such a limiting degree and a preventing degree are both visual blocking degrees. In some embodiments, visual blocking degrees of different regions in the virtual environment may be different. In some embodiments, visual blocking degrees of the same region in the virtual environment in different time periods may be different.

In some embodiments, visual blocking degrees of different region environments or visual blocking degrees of a region in different time periods may be pre-configured. For example, a parameter value of 0% to 100% may be configured for denoting the visual blocking degree. For example, in a completely dark environmental region, a visual blocking degree may be 100%. In a coverage region of fog, a visual blocking degree may be 60%. In a region not blocking vision (that is, a non-visual blocking region), a visual blocking degree may be 0.

In some embodiments, in a coverage region of the smoke generated by the smoke bomb, the visual blocking degree may change with duration from time of detonation of the smoke bomb. For example, in a first time period after the detonation, the visual blocking degree of the coverage region of the smoke may be 100%. In a second time period after the detonation, a visual blocking degree of the coverage region of the smoke may be 50%. After the second time period, the visual blocking degree of the coverage region of the smoke may be 0. The first time period and the second time period are two adjacent but non-overlapping time periods. The first time period is before the second time period. Thus, display interval duration corresponding to the first time period is greater than display interval duration corresponding to the second time period. The display interval duration corresponding to the second time period is greater than display interval duration corresponding to a time period after the second time period. For example, the display interval duration corresponding to the first time period may be 3 s. The display interval duration corresponding to the second time period may be 2 s. The display interval duration after the second time period may be 1 s.

In some embodiments, operation 920 may further include the following operations:
1: Display the voiceprint identifier according to the first interval duration when the first virtual object is located in the visual blocking region in the virtual environment, the visual blocking region being configured for visually blocking the virtual element in the region; and
2: display the voiceprint identifier according to the second interval duration when the first virtual object is located in the non-visual blocking region in the virtual environment, the non-visual blocking region being a region other than the visual blocking region;
a visual blocking degree of the visual blocking region being greater than a visual blocking degree of the non-visual blocking region, and the first interval duration being greater than the second interval duration.

In some embodiments, a region of which a visual blocking degree is greater than 0 in the virtual environment may be referred to as the visual blocking region. A region of which a visual blocking degree is 0 may be referred to as a non-visual blocking region. Apparently, an allowed displaying frequency of the voiceprint identifier of the non-visual blocking region is to be greater than an allowed displaying frequency of the voiceprint identifier of the visual blocking region. Thus, the first interval duration is to be longer than the second interval duration.

According to the technical solutions provided in the embodiments of present disclosure, the voiceprint identifiers are displayed in the visual blocking region and outside the visual blocking region through different display time intervals respectively, such that flexibility and diversity of displaying modes for voiceprint identifiers are reflected. In addition, visual blocking and voiceprint displaying are combined in a mode of improving a time interval at which the voiceprint identifier is displayed in the visual blocking region. Thus, forms of human-computer interactions are enriched, and displaying modes for voiceprint identifiers are enriched.

In some embodiments, the visual blocking region includes at least two subregions having different visual blocking degrees, and visual blocking degrees of different locations in the same subregion are the same. Operation: display the voiceprint identifier according to the first interval duration when the first virtual object is located in the visual blocking region in the virtual environment includes the following operations:
1. Acquire, when the first virtual object is located in the visual blocking region, a location at which the first virtual object triggers the sound-generating event;
2. determine, according to the location at which the first virtual object triggers the sound-generating event, a subregion in which the first virtual object triggers the sound-generating event; and
3. determine display interval duration corresponding to the subregion in which the first virtual object triggers the sound-generating event as the first interval duration, and display the voiceprint identifier according to the first interval duration.

In some embodiments, visual blocking degrees of different locations or different subregions of the visual blocking region may be different. If the first virtual object is located in the visual blocking region, a location at which the first virtual object triggers the sound-generating event is first acquired. For example, coordinates of the first virtual object triggering the sound-generating event are acquired. A subregion in which the first virtual object triggers the sound-generating event can be determined according to the coordinates. Display interval duration corresponding to the visual blocking degree of the subregion is determined as the first interval duration. Thus, the voiceprint identifier of the sound-generating event triggered in the subregion is displayed according to the first interval duration.

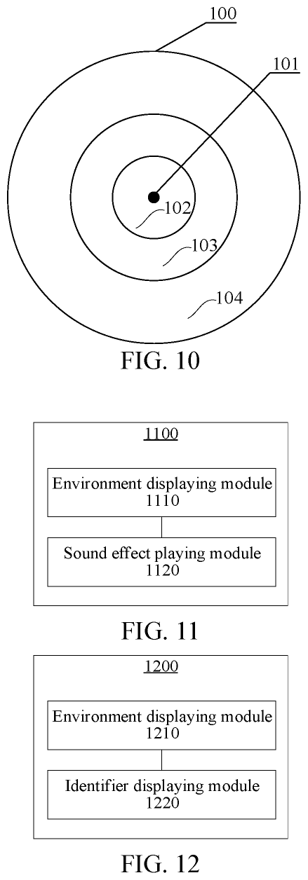

In some embodiments, the visual blocking region is a coverage region of smoke generated by a smoke bomb. In some embodiments, a bottom surface of the coverage region is a bottom surface with a landing location of a smoke bomb as a central point. In some embodiments, in the coverage region, visual blocking degrees of vertical locations are the same. Thus, subregions can be divided and determined based on any cross section (such as a bottom surface) bottom surface of the coverage region. The visual blocking region 80 shown in FIG. 8 actually is a bottom surface of the visual blocking region 80. In some embodiments, since the smoke diffuses from the smoke bomb, the closer a region to a landing location of the smoke bomb, the higher concentration of the smoke, and the higher the visual blocking degree. The farther a region from the landing location of the smoke bomb, the less the smoke, and the lower the visual blocking degree. Thus, the subregions may be divided according to distances from the landing location of the smoke bomb. The distances from the landing location of the smoke bomb may be divided into a plurality of continuous distance ranges. Each distance range corresponds to one subregion. As shown in FIG. 10, the coverage region 100 may be a cylindrical region, and a bottom surface of the coverage region 100 may be in a shape of a circle. Three distance ranges can be obtained through division according to distances to a landing location 101 of a smoke bomb, and three subregions are obtained. A subregion 102, a subregion 103, and a subregion 104 are obtained from near to far according to distances to the landing location 101. Apparently, a visual blocking degree of the subregion 102 is greater than a visual blocking degree of the subregion 103, and the visual blocking degree of the subregion 103 is greater than a visual blocking degree of the subregion 104.

In the embodiment, in the visual blocking region, display interval duration for displaying the voiceprint identifier may be different. Thus, differentiation between different regions of the visual blocking region is enriched, and functions of the visual blocking region are enriched. In addition, different subregions of the visual blocking region are combined with displaying of the voiceprint identifier, such that displaying modes for the voiceprint identifier relative to users are more diversified.

In conclusion, according to the technical solutions provided in the embodiments of present disclosure, the display interval duration for displaying the voiceprint identifier is limited according to the visual blocking degree, such that a displaying frequency of the voiceprint identifier is lower in a region having a higher visual blocking degree, and a displaying frequency of the voiceprint identifier is higher in a region having a lower visual blocking degree. In this way, displaying of the voiceprint identifier is coordinated and unified with visual blocking effects of different regions. Displaying forms of the voiceprint identifier are enriched, and user experience is improved.

In some embodiments, operation 920 may be replaced with the following operations:
1. Determine a distance between the first virtual object and a second virtual object in the virtual environment;
2. determine an amplitude of the voiceprint identifier according to the visual blocking degree of the region in which the first virtual object is located and the distance; and
3. determine, according to the amplitude, a voiceprint identifier corresponding to the sound-generating event triggered by the first virtual object; for the same visual blocking degree, the amplitude having a negative correlation with the distance; and for the same distance, the amplitude having a negative correlation with the visual blocking degree.

In some embodiments, the voiceprint identifier may be a voiceprint identifier in a waveform. An amplitude of the waveform may be configured for denoting loudness or a volume of a sound effect corresponding to a sound-generating event. The greater the amplitude, the higher the loudness or the volume. The less the amplitude, the lower the loudness or the volume. The loudness and the volume are further related to the distance between the first virtual object and the second virtual object, and the visual blocking degree of the region in which the first virtual object is located. Thus, the amplitude of the voiceprint identifier is required to be determined by combining these two factors.

In some embodiments, the visual blocking degree of the region, the distance, and the amplitude of the voiceprint identifier have a one-to-one corresponding relationship (or a functional relationship). Exemplarily, after the visual blocking degree of the region and the distance are determined or acquired, an amplitude corresponding to the visual blocking degree of the region and the distance is found from the corresponding relationship. Exemplarily, after the visual blocking degree of the region and the distance are determined or acquired, an amplitude corresponding to the visual blocking degree of the region and the distance is computed according to a functional relationship.

In some embodiments, the amplitude has a negative correlation with the distance, the amplitude has a negative correlation with the visual blocking degree, and the amplitude, the distance, and the visual blocking degree have a functional relationship. Exemplarily, amplitude=a*distance+b*visual blocking degree. Specifically, a and b are negative numbers.

In some embodiments, as shown in subfigure (a) and subfigure (b) of FIG. 1, a region 12 in which the virtual object 11 is located in subfigure (a) is a non-visual blocking region, and a region in which the virtual object 11 is located in subfigure (b) is a coverage region 13 of smoke, that is, a visual blocking region. Apparently, a visual blocking degree of the region 12 is less than a visual blocking degree of the coverage region 13. Thus, when a distance between the virtual object 11 and the second virtual object 16 is the same, an amplitude of a voiceprint identifier 17 of a sound-generating event triggered by the virtual object 11 in the region 12 is greater than an amplitude of a voiceprint identifier 18 of a sound-generating event triggered by the virtual object 11 in the coverage region 13.

In some embodiments, after the voiceprint identifier corresponding to the sound-generating event triggered by the first virtual object is determined, the voiceprint identifier corresponding to the sound-generating event triggered by the first virtual object is displayed.

In the above implementation, the amplitude of the voiceprint identifier has a negative correlation with the distance and the visual blocking degree. After the virtual object moves from the outside of the visual blocking region to the inside of the visual blocking region, the display interval duration of the voiceprint identifier of the correspondingly triggered sound-generating event is reduced. Thus, diversity and richness of displaying modes for voiceprint identifiers are improved. In addition, richness and fun of game content are improved, and user attraction is enhanced.

In some embodiments, an orientation compass is displayed in an upper-layer picture of a display picture of the virtual environment. The orientation compass is configured for indicating an orientation of the second virtual object in the virtual environment. The voiceprint identifier corresponds to a location on the orientation compass and is configured for indicating a direction of a trigger location of a sound-generating event corresponding to the voiceprint identifier relative to the second virtual object.

In some embodiments, as shown in FIG. 1, when displaying the virtual environment, the client may further display the orientation compass 19. In some embodiments, an orientation right in the middle of the displayed orientation compass is kept as an orientation to which the second virtual object faces. In some embodiments, each voiceprint identifier can correspond to one direction in the orientation compass. For example, a direction corresponding to a scale at which a point of the voiceprint identifier perpendicular to the orientation compass is located is a direction indicated by the voiceprint identifier. In some embodiments, the voiceprint identifier may be displayed on the orientation compass. According to the embodiment, the voiceprint identifier may further be configured for indicating a direction of the sound-generating event corresponding to the second virtual object, to be specific, configured for indicating a direction of the first virtual object corresponding to the second virtual object. Thus, functions of the voiceprint identifier are enriched.

In some embodiments, a difference between a direction indicated by the voiceprint identifier at the corresponding location on the orientation compass and the direction of the sound-generating event corresponding to the voiceprint identifier relative to the second virtual object is a direction difference. The direction difference has a positive correlation with the visual blocking degree of the region in which the first virtual object is located.

In some embodiments, when the first virtual object is located in the visual blocking region, a direction of the first virtual object indicated by a corresponding voiceprint identifier may deviate from an actual direction. To be specific, accuracy of the direction indicated by the voiceprint identifier is reduced. Thus, it is not easy for a user to accurately determine the location of the first virtual object through the voiceprint identifier. A blocking effect of the visual blocking region on the virtual object in the region is improved.

In the above implementation, the voiceprint identifier may be configured for indicating a direction. When the first virtual object is located in the visual blocking region, the voiceprint identifier may further be configured for blurring sensing and positioning of the user on the location of the first virtual object. Thus, functions and actions of the voiceprint identifier are enriched. Moreover, the blocking effect of the visual blocking region on the virtual object in the region is improved.

The above embodiments of the method for playing a sound effect and the above embodiments of the method for displaying a voiceprint identifier may be combined. Any feasible embodiments formed by combining the embodiments of the method for playing a sound effect and the embodiments of the method for displaying a voiceprint identifier fall within the scope of protection of present disclosure.

The embodiments of the apparatuses in present disclosure are described below, and can be configured for implementing the embodiments of the methods in present disclosure. For details not disclosed in the embodiments of the apparatuses in present disclosure, reference can be made to the embodiments of the methods in present disclosure.

With reference to FIG. 11, a block diagram of an apparatus for playing a sound effect according to an embodiment of present disclosure is shown. The apparatus has functions for implementing examples of the above method for playing a sound effect. The functions may be implemented by hardware, or may be implemented by hardware executing corresponding software. The apparatus may be the terminal device introduced above, or may be arranged on the terminal device. The apparatus 1100 may include an environment displaying module 1110 and a sound effect playing module 1120.

The environment displaying module 1110 is configured to display a virtual environment including a first virtual object.

The sound effect playing module 1120 is configured to play, when the first virtual object is located in a visual blocking region in the virtual environment and the first virtual object triggers a sound-generating event in the visual blocking region, a sound effect of the sound-generating event after reduction processing, the visual blocking region being configured for producing a blocking effect on a virtual element in the region, and the reduction processing being configured for reducing an effect of the sound effect in distinguishing a location of the first virtual object.

In some embodiments, the sound effect playing module 1120 includes a parameter acquiring submodule and a sound effect playing submodule.

The parameter acquiring submodule is configured to acquire an initial sound effect parameter of the sound-generating event.

The parameter acquiring submodule is further configured to perform the reduction processing on an initial sound effect of the sound-generating event based on the initial sound effect parameter of the sound-generating event, and obtain a reduced sound effect parameter of the sound-generating event.

The sound effect playing submodule is configured to play a sound effect of the at least once sound-generating event according to the reduced sound effect parameter of the at least once sound-generating event.

In some embodiments, the sound effect parameter includes a volume value. The parameter acquiring submodule is configured to determine a reduced volume value of the sound-generating event based on an initial volume value of the sound-generating event, the reduced volume value of the sound-generating event being less than the initial volume value of the sound-generating event.

In some embodiments, the sound effect parameters include a spatial parameter. The parameter acquiring submodule is configured to determine a reduced spatial parameter of the sound-generating event based on an initial spatial parameter of the sound-generating event, an effect of the reduced spatial parameter in distinguishing a direction and a distance of a sound-generating location being less than an effect of the initial spatial parameter in distinguishing the direction and the distance of the sound-generating location.

In some embodiments, the spatial parameter includes a time difference and a volume difference between respective sound effects of at least two sound channels. The parameter acquiring submodule is configured to determine, based on an initial time difference or an initial volume difference between the respective sound effects of the at least two sound channels of the first sound-generating event, a reduced time difference or a reduced volume difference of the first sound-generating event.

In some embodiments, the parameter acquiring submodule is configured to determine, based on frequency limitation information corresponding to the visual blocking region, whether the first sound-generating event belongs to a sound effect playing event or a sound effect hiding event, the frequency limitation information being configured for limiting a playing frequency of the sound effect of the sound-generating event, the sound effect playing event being a sound-generating event of playing a corresponding sound effect, and the sound effect hiding event being a sound-generating event of hiding the corresponding sound effect.

The sound effect playing submodule is configured to:
play the sound effect of the first sound-generating event when the first sound-generating event belongs to the sound effect playing event;
when the sound-generating event belongs to the sound effect hiding event, the sound effect of the sound-generating event being not played.

In some embodiments, the frequency limitation information includes at least one of the following:
within first duration, a quantity of sound effect playing events is less than or equal to a first threshold;
every n continuous sound-generating events include m sound-generating events that belong to sound effect playing events, n and m are integers greater than 1, and m is less than n; and
the sound effect playing event or the sound effect hiding event is randomly determined.

In some embodiments, the visual blocking region includes a coverage region of smoke generated by a virtual smoke apparatus in the virtual environment, and a central point of a bottom surface of the coverage region is a location at which the virtual smoke apparatus generates the smoke.

In some embodiments, the visual blocking region includes at least two subregions having different visual blocking degrees, and visual blocking degrees of different locations in the same subregion are the same. When a sound-generating location of the sound-generating event is in a first subregion of the at least two subregions, a sound effect of the sound-generating event after the reduction processing is determined based on a visual blocking degree of the first subregion. The reducing effect of the sound effect of the sound-generating event after the reduction processing in distinguishing the location of the first virtual object has a positive correlation with the visual blocking degree.

In some embodiments, the sound effect playing module 1120 is further configured to:
play an initial sound effect of the sound-generating event when the first virtual object is moved out of the visual blocking region or the visual blocking region is canceled and if the first virtual object triggers the sound-generating event.

In some embodiments, the sound effect playing module 1120 is further configured for that the sound effect of the sound-generating event after the reduction processing is determined based on the type of the sound-generating event. Reduction processing modes corresponding to different types of sound-generating events are different.

In some embodiments, the sound effect playing module 1120 is further configured for that
when the sound-generating event is a sound-generating event of a location change type, the sound effect of the sound-generating event after the reduction processing is a sound effect of the sound-generating event after first reduction processing, and the sound-generating event of the location change type is configured for changing the location of the first virtual object;
when the sound-generating event is a sound-generating event of an attack type, the sound effect of the sound-generating event after the reduction processing is a sound effect of the sound-generating event after second reduction processing, and the sound-generating event of the attack type is configured for attacking a second virtual object in the virtual environment; and
a reducing degree of the first reduction processing on the sound effect is greater than a reducing degree of the second reduction processing on the sound effect.

In conclusion, according to the technical solutions provided in the embodiments of present disclosure, when a virtual object is located in a visual blocking region of a virtual environment, reduction processing is performed on a sound effect of a sound-generating event triggered by the virtual object in the visual blocking region, such that an effect of a played sound effect after the reduction processing in distinguishing a sound-generating location is reduced. Considering that visual blocking (such as existence of an obstacle) may block sound propagation (the obstacle reflects, refracts, etc. a sound), visual blocking and auditory sound effect reducing are organically combined such that a more realistic sound effect in a visual blocking situation can be simulated. Diversity of played sound effects is enhanced, a user is provided with immersive experience, and battle experience of the user is improved. The sound effect is merely reduced rather than completely canceled, and the location of the first virtual object can still be sensed based on the sound effect. In addition, through the played sound effect after the reduction processing, the location of the first virtual object is more difficult to distinguish. Forms of human-computer interactions are enriched and game interest is improved while richness of sound effects is improved. In addition, in the embodiments of present disclosure, the visual blocking region can visually block a virtual object located in the visual blocking region, and a location of the virtual object can be auditorily blurred through the reduction processing on the sound effect. Thus, functions of the visual blocking region are enriched.

With reference to FIG. 12, a block diagram of an apparatus for displaying a voiceprint identifier according to an embodiment of present disclosure is shown. The apparatus has a function for implementing the above examples of the method for displaying a voiceprint identifier. The function may be implemented by hardware, or may be implemented by hardware executing corresponding software. The apparatus may be the terminal device introduced above, or may be arranged on the terminal device. The apparatus 1200 may include an environment displaying module 1210 and an identifier displaying module 1220.

The environment displaying module 1210 is configured to display a virtual environment including a first virtual object.

The identifier displaying module 1220 is configured to display, based on a visual blocking degree of a region in which the first virtual object is located, a voiceprint identifier corresponding to a sound-generating event triggered by the first virtual object, the visual blocking degree being configured for indicating a degree of a blocking effect produced on a virtual element in the region, the voiceprint identifier being configured for denoting a direction and a location of the first virtual object, and display interval duration between two adjacent voiceprint identifiers having a positive correlation with the visual blocking degree of the region in which the first virtual object is located.

In some embodiments, the identifier displaying module 1220 is configured to:
display the voiceprint identifier according to first interval duration when the first virtual object is located in a visual blocking region in the virtual environment, the visual blocking region being configured for producing the blocking effect on the virtual element in the region; and
display the voiceprint identifier according to second interval duration when the first virtual object is located in a non-visual blocking region in the virtual environment, the non-visual blocking region being a region other than the visual blocking region;
a visual blocking degree of the visual blocking region being greater than a visual blocking degree of the non-visual blocking region, and the first interval duration being greater than the second interval duration.

In some embodiments, the visual blocking region includes at least two subregions having different visual blocking degrees, and visual blocking degrees of different locations in the same subregion are the same.

In some embodiments, the identifier displaying module 1220 is configured to:
acquire, when the first virtual object is located in the visual blocking region, a location at which the first virtual object triggers the sound-generating event;
determine, according to the location at which the first virtual object triggers the sound-generating event, a subregion in which the first virtual object triggers the sound-generating event; and
determine display interval duration corresponding to the subregion in which the first virtual object triggers the sound-generating event as the first interval duration, and display the voiceprint identifier according to the first interval duration.

In some embodiments, the identifier displaying module 1220 is configured to:
determine a distance between the first virtual object and a second virtual object in the virtual environment;
determine an amplitude of the voiceprint identifier according to the visual blocking degree of the region in which the first virtual object is located and the distance; and
determine, according to the amplitude, a voiceprint identifier corresponding to the sound-generating event triggered by the first virtual object;
for the same visual blocking degree, the amplitude having a negative correlation with the distance; and for the same distance, the amplitude having a negative correlation with the visual blocking degree.

In some embodiments, an orientation compass is displayed in an upper-layer picture of a display picture of the virtual environment. The orientation compass is configured for indicating an orientation of the second virtual object in the virtual environment. The voiceprint identifier corresponds to a location on the orientation compass and is configured for indicating a direction of a trigger location of a sound-generating event corresponding to the voiceprint identifier relative to the second virtual object.

In some embodiments, a difference between a direction indicated by the voiceprint identifier at the corresponding location on the orientation compass and the direction of the sound-generating event corresponding to the voiceprint identifier relative to the second virtual object is a direction difference. The direction difference has a positive correlation with the visual blocking degree of the region in which the first virtual object is located.

In conclusion, according to the technical solutions provided in the embodiments of present disclosure, the display interval duration for displaying the voiceprint identifier is limited according to the visual blocking degree, such that a displaying frequency of the voiceprint identifier is lower in a region having a higher visual blocking degree, and a displaying frequency of the voiceprint identifier is higher in a region having a lower visual blocking degree. In this way, displaying of the voiceprint identifier is coordinated and unified with visual blocking effects of different regions. User experience is improved.

When the apparatus provided in the above embodiments implements its functions, division of the above functional modules is taken as an example for description. During actual application, the above functions may be allocated to different functional modules for completion according to requirements. To be specific, internal structures of the device are divided into different functional modules to complete all or some of the functions described above. In addition, the apparatus provided in the above embodiments and the method provided in the above embodiments belong to the same conception. For a specific implementation process, reference can be made to the embodiments of the method. Details are not repeated herein.

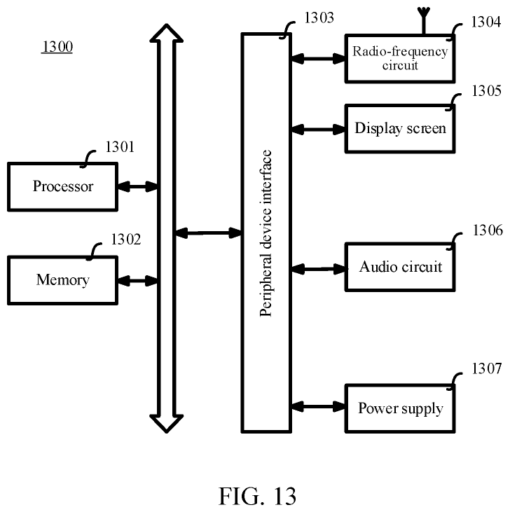

With reference to FIG. 13, a structural block diagram of a terminal device 1300 according to an embodiment of present disclosure is provided. The terminal device 1300 may be an electronic device such as a mobile phone, a tablet computer, a game console, an ebook reader, a multimedia player, a wearable device, or a personal computer (PC). The terminal device is configured to implement the method for playing a sound effect or the method for displaying a voiceprint identifier provided in the above embodiments. The terminal device may be the terminal device 14 in the computer system shown in FIG. 2. Specifically, generally, the terminal device 1300 includes a processor 1301 and a memory 1302.

The processor 1301 may include one or more processing cores, such as a 4-core processor or an 8-core processor. The processor 1301 may be implemented in at least one hardware form of a digital signal processor (DSP), a field programmable gate array (FPGA), and a programmable logic array (PLA). The processor 1301 may alternatively include a main processor and a coprocessor. The main processor is a processor configured to process data in an awake state, and is alternatively referred to as a central processing unit (CPU). The coprocessor is a low power consumption processor configured to process the data in a standby state. In some embodiments, the processor 1301 may be integrated with a graphics processing unit (GPU). The GPU is configured to render and draw content that is required to be displayed on a display screen. In some embodiments, the processor 1301 may further include an artificial intelligence (AI) processor. The AI processor is configured to process computing operations related to machine learning.

The memory 1302 may include one or more computer-readable storage media. The computer-readable storage media may be non-transitory. The memory 1302 may further include a high speed random access memory and a non-volatile memory, such as one or more disk storage devices or flash storage devices. In some embodiments, the non-transitory computer-readable storage medium in the memory 1302 is configured for storing a computer program, the computer program being configured to be executed by one or more processors to implement the above method for playing a sound effect or the above method for displaying a voiceprint identifier.

In some embodiments, the terminal device 1300 may alternatively include a peripheral device interface 1303 and at least one peripheral device. The processor 1301, the memory 1302, and the peripheral device interface 1303 may be connected by a bus or a signal line. Each peripheral device may be connected to peripheral device interface 1303 by a bus, a signal line, or a circuit board. Specifically, the peripheral device includes at least one of a radio-frequency circuit 1304, a display screen 1305, an audio circuit 1306, and a power supply 1307.

A person skilled in the art can understand that the structure shown in FIG. 13 constitutes no limitation on the terminal device 1300. The terminal may include more or fewer components than those shown in the figure, or some components are combined, or different component arrangements are used.

In one exemplary embodiment, a computer-readable storage medium is further provided. The storage medium has a computer program stored therein, the computer program, when executed by a processor, implementing the above method for playing a sound effect or implementing the above method for displaying a voiceprint identifier.

In some embodiments, the computer-readable storage medium may include a read-only memory (ROM), a random-access memory (RAM), solid state drives (SSDs), or an optical disc, etc. The random access memory may include a resistance random access memory (ReRAM) and a dynamic random access memory (DRAM).

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

In one exemplary embodiment, a computer program product is further provided. The computer program product includes a computer program, the computer program being stored in a computer-readable storage medium. A processor of a computer device reads the computer program from the computer-readable storage medium, and the processor executes the computer program to cause the computer device to perform the above method for playing a sound effect or perform the above method for displaying a voiceprint identifier.

In present disclosure, before and when user-related data is collected, a prompt interface or a pop-up window can be displayed, or voice prompt information can be outputted. The prompt interface, the pop-up window, or the voice prompt information is configured for prompting the user that user-related data is currently being collected. In this way, in present disclosure, related operations of acquiring the user-related data start to be performed only after a confirmation operation by the user on the prompt interface or the pop-up window is acquired. Otherwise (that is, when no confirmation operation by the user on the prompt interface or the pop-up window is acquired), the related operations of acquiring the user-related data are ended, that is, the user-related data is not to be obtained. In other words, in present disclosure, all the collected user data is collected with user consent and authorization, and collection, usage, and processing of the related user data are required to comply with related laws, regulations, and standards of related countries and regions.

The term “a plurality of” mentioned herein refers to two or more. The term “and/or” describing an association relationship between associated objects indicates that there can be three relations. For example, A and/or B can denote A alone, both A and B, and B alone. The character “/” generally denotes an “or” relationship between the associated objects.

The technical solutions provided in the embodiments of present disclosure can include beneficial effects as follows:

On one hand, when a virtual object is located in a visual blocking region of a virtual environment, reduction processing is performed on a sound effect of a sound event triggered by the virtual object in the visual blocking region, such that an effect of a played sound effect after the reduction processing in distinguishing a sound-generating location is reduced. Considering that visual blocking (such as existence of an obstacle) may block sound propagation (the obstacle reflects, refracts, etc. a sound), visual blocking and auditory sound effect reducing are organically combined such that a more realistic sound effect in a visual blocking situation can be simulated. Diversity of played sound effects is enhanced, a user is provided with immersive experience, and battle experience of the user is improved.

On the other hand, the sound effect is merely reduced rather than completely canceled, and the sound event triggered by the first virtual object can still be sensed based on the sound effect (for example, it is sensed that the first virtual object is walking or launching an attack). A sensing effect on a sound-generating location of the first virtual object is reduced by reducing the sound effect of the sound event, such that the sound-generating location of the first virtual object is more difficult to distinguish. Forms of human-computer interactions are enriched and game interest is improved while richness of sound effects is improved.

Moreover, in the embodiments of present disclosure, the visual blocking region can visually block a virtual object located in the visual blocking region, and a location of the virtual object can be auditorily blurred through the reduction processing on the sound effect. Thus, functions of the visual blocking region are enriched

The above embodiments are merely exemplary embodiments of present disclosure, and not intended to limit present disclosure. Any modifications, equivalent substitutions, improvements, etc. made within the spirit and principles of present disclosure are to all fall within the scope of protection of present disclosure.

What is claimed is:

1. A method for playing a sound effect, performed by a terminal device, the method comprising:
displaying a virtual environment comprising a first virtual object; and
playing, in response to that the first virtual object is located in a visual blocking region in the virtual environment and the first virtual object triggers a sound-generating event in the visual blocking region, a sound effect of the sound-generating event after reduction processing, the visual blocking region being configured for producing a blocking effect on a virtual element in the visual blocking region, and the reduction processing being configured for reducing an effect of the sound effect in distinguishing a location of the first virtual object.

2. The method according to claim 1, wherein playing the sound effect of the sound-generating event after reduction processing comprises:
acquiring an initial sound effect parameter of the sound-generating event;
performing the reduction processing on an initial sound effect of the sound-generating event based on the initial sound effect parameter of the sound-generating event, and obtaining a reduced sound effect parameter of the sound-generating event; and
playing the sound effect of the sound-generating event according to the reduced sound effect parameter of the sound-generating event.

3. The method according to claim 2, wherein the sound effect parameter comprises a volume value; and
performing the reduction processing on the initial sound effect of the sound-generating event based on the initial sound effect parameter of the sound-generating event, and obtaining the reduced sound effect parameter of the sound-generating event comprise:
determining a reduced volume value of the sound-generating event based on an initial volume value of the sound-generating event, the reduced volume value of the sound-generating event being less than the initial volume value of the sound-generating event.

4. The method according to claim 2, wherein the sound effect parameter comprises a spatial parameter; and
performing the reduction processing on the initial sound effect of the sound-generating event based on the initial sound effect parameter of the sound-generating event, and obtaining the reduced sound effect parameter of the sound-generating event comprise:
determining a reduced spatial parameter of the sound-generating event based on an initial spatial parameter of the sound-generating event, an effect of the reduced spatial parameter in distinguishing a direction and a distance of a sound-generating location being less than an effect of the initial spatial parameter in distinguishing the direction and the distance of the sound-generating location.

5. The method according to claim 4, wherein the spatial parameter comprises a time difference and a volume difference between respective sound effects of at least two sound channels; and
determining the reduced spatial parameter of the sound-generating event based on the initial spatial parameter of the sound-generating event comprises:
determining a reduced time difference or a reduced volume difference of the sound-generating event based on an initial time difference or an initial volume difference between the respective sound effects of the at least two sound channels of the sound-generating event.

6. The method according to claim 2, wherein performing the reduction processing on the initial sound effect of the sound-generating event based on the initial sound effect parameter of the sound-generating event, and obtaining the reduced sound effect parameter of the sound-generating event comprise:
determining, based on frequency limitation information corresponding to the visual blocking region, whether the sound-generating event belongs to a sound effect playing event or a sound effect hiding event, the frequency limitation information being configured for limiting a playing frequency of the sound effect of the sound-generating event, the sound effect playing event being a sound-generating event of playing a corresponding sound effect, and the sound effect hiding event being a sound-generating event of hiding the corresponding sound effect; and
playing the sound effect of the sound-generating event according to the reduced sound effect parameter of the sound-generating event comprises:
playing the sound effect of the sound-generating event when the sound-generating event belongs to the sound effect playing event, wherein
when the sound-generating event belongs to the sound effect hiding event, the sound effect of the sound-generating event is not played.

7. The method according to claim 1, wherein the visual blocking region comprises an effective region of smoke generated by a virtual smoke apparatus in the virtual environment.

8. The method according to claim 1, wherein the visual blocking region comprises at least two subregions having different visual blocking degrees, and different locations in a same subregion have a same visual blocking degree;
when the sound-generating location of the sound-generating event is in a first subregion of the at least two subregions, the sound effect of the sound-generating event after the reduction processing is determined based on a visual blocking degree of the first subregion; and
a reducing effect of the sound effect of the sound-generating event after the reduction processing in distinguishing the location of the first virtual object has a positive correlation with the visual blocking degree.

9. The method according to claim 1, wherein
the sound effect of the sound-generating event after the reduction processing is determined based on a type of the sound-generating event; and
reduction processing modes corresponding to different types of sound-generating events are different.

10. The method according to claim 9, wherein
when the sound-generating event is a sound-generating event of a location change type, the sound effect of the sound-generating event after the reduction processing is a sound effect of the sound-generating event after first reduction processing, and the sound-generating event of the location change type is configured for changing the location of the first virtual object;
when the sound-generating event is a sound-generating event of an attack type, the sound effect of the sound-generating event after the reduction processing is a sound effect of the sound-generating event after second reduction processing, and the sound-generating event of the attack type is configured for attacking a second virtual object in the virtual environment; and
a reducing degree of the first reduction processing on the sound effect is greater than a reducing degree of the second reduction processing on the sound effect.

11. A terminal device, comprising:
one or more processors and a memory containing a computer program that, when being executed, causes the one or more processors to perform:
displaying a virtual environment comprising a first virtual object; and
playing, in response to that the first virtual object is located in a visual blocking region in the virtual environment and the first virtual object triggers a sound event in the visual blocking region, a sound effect of the sound event after reduction processing, the visual blocking region being configured for producing a blocking effect on a virtual element in the visual blocking region, and the reduction processing being configured for reducing an effect of the sound effect in distinguishing a location of the first virtual object.

12. The device according to claim 11, wherein the one or more processors are further configured to perform:
acquiring an initial sound effect parameter of the sound event;
performing the reduction processing on an initial sound effect of the sound event based on the initial sound effect parameter of the sound event, and obtaining a reduced sound effect parameter of the sound event; and
playing the sound effect of the sound event according to the reduced sound effect parameter of the sound event.

13. The device according to claim 12, wherein the sound effect parameter comprises a volume value; and
the one or more processors are further configured to perform:
determining a reduced volume value of the sound event based on an initial volume value of the sound event, the reduced volume value of the sound event being less than the initial volume value of the sound event.

14. The device according to claim 12, wherein the sound effect parameter comprises a spatial parameter; and
the one or more processors are further configured to perform:
determining a reduced spatial parameter of the sound event based on an initial spatial parameter of the sound event, an effect of the reduced spatial parameter in distinguishing a direction and a distance of a sound-generating location being less than an effect of the initial spatial parameter in distinguishing the direction and the distance of the sound-generating location.

15. The device according to claim 14, wherein the spatial parameter comprises a time difference and a volume difference between respective sound effects of at least two sound channels; and
the one or more processors are further configured to perform:
determining a reduced time difference or a reduced volume difference of the sound event based on an initial time difference or an initial volume difference between the respective sound effects of the at least two sound channels of the sound event.

16. The device according to claim 12, wherein the one or more processors are further configured to perform:
determining, based on frequency limitation information corresponding to the visual blocking region, whether the sound event belongs to a sound effect playing event or a sound effect hiding event, the frequency limitation information being configured for limiting a playing frequency of the sound effect of the sound event, the sound effect playing event being a sound event of playing a corresponding sound effect, and the sound effect hiding event being a sound event of hiding the corresponding sound effect; and
playing the sound effect of the sound event according to the reduced sound effect parameter of the sound event comprises:
playing the sound effect of the sound event when the sound event belongs to the sound effect playing event, wherein when the sound event belongs to the sound effect hiding event, the sound effect of the sound event is not played.

17. The device according to claim 11, wherein the visual blocking region comprises an effective region of smoke generated by a virtual smoke apparatus in the virtual environment.

18. The device according to claim 11, wherein the visual blocking region comprises at least two subregions having different visual blocking degrees, and different locations in a same subregion have a same visual blocking degree;
when the sound-generating location of the sound event is in a first subregion of the at least two subregions, the sound effect of the sound event after the reduction processing is determined based on a visual blocking degree of the first subregion; and
a reducing effect of the sound effect of the sound event after the reduction processing in distinguishing the location of the first virtual object has a positive correlation with the visual blocking degree.

19. The device according to claim 11, wherein
the sound effect of the sound event after the reduction processing is determined based on a type of the sound event; and
reduction processing modes corresponding to different types of sound events are different.

20. A non-transitory computer-readable storage medium containing a computer program that, when being executed, causes at least one processor to perform:
displaying a virtual environment comprising a first virtual object; and
playing, in response to that the first virtual object is located in a visual blocking region in the virtual environment and the first virtual object triggers a sound event in the visual blocking region, a sound effect of the sound event after reduction processing, the visual blocking region being configured for producing a blocking effect on a virtual element in the visual blocking region, and the reduction processing being configured for reducing an effect of the sound effect in distinguishing a location of the first virtual object.
